(19) United States
(12) Patent Application Publication
(10) Pub. No.: US 2024/0071662 A1
(43) Pub. Date: Feb. 29, 2024

(54) METAL MAGNETIC POWDER, COMPOSITE MAGNETIC BODY, AND ELECTRONIC COMPONENT

(71) Applicant: TDK CORPORATION, Tokyo (JP)

(72) Inventors: Kyohei TAKAHASHI, Tokyo (JP); Hiroshi ITO, Tokyo (JP); Isao KANADA, Tokyo (JP)

(73) Assignee: TDK CORPORATION, Tokyo (JP)

(21) Appl. No.: 18/455,842

(22) Filed: Aug. 25, 2023

(30) Foreign Application Priority Data
Aug. 26, 2022 (JP) 2022-135205

(51) Int. Cl. H01F 1/20; B22F 1/054; B22F 1/145; B22F 3/02; B22F 9/04; B22F 9/30; C22C 19/00; C22C 19/07

(52) U.S. Cl. CPC H01F 1/20; B22F 1/054; B22F 1/147; B22F 3/02; B22F 9/04; B22F 9/30; C22C 19/002; C22C 19/007; C22C 19/07; B22F 2201/11; B22F 2202/01; B22F 2301/15; B22F 2304/054; B22F 2998/10; B22F 2999/00; C22C 2202/02

(57) ABSTRACT

The metal magnetic powder includes Co as a main component, and an average particle size (D50) of 1 nm to 100 nm. An X-ray diffraction chart of the metal magnetic powder has a first peak that appears in a range of a diffraction angle 2θ of 41.6±0.3°, and a second peak that appears in a range of a diffraction angle 20θ of 47.4±0.3°. When a full width at half maximum of the first peak is set as FW1, and a full width at half maximum of the second peak is set as FW2, a ratio (FW2/FW1) of FW2 to FW1 is 1 to 5.

### BACKGROUND OF THE INVENTION

### 1. Field of the Invention

The present disclosure relates to a metal magnetic powder including metal nanoparticles including Co as a main component, a composite magnetic body, and an electronic component.

### 2. Description of the Related Art

In recent years, in a high-frequency circuit included in various communication devices such as a mobile phone and a wireless LAN device, an operation frequency reaches a gigahertz band (for example, 3.7 GHz band (3.6 to 4.2 GHz), 4.5 GHz band (4.4 to 4.9 GHz band)). Examples of an electronic component mounted at the high-frequency circuit include an inductor, an antenna, a filter for high-frequency noise countermeasure, and the like. As a coil that is embedded in the electronic component for high frequencies, a coreless coil including a non-magnetic magnetic core is typically used, but there is a demand for development of a magnetic material applicable to the electronic component for high frequencies in order to improve characteristics of the electronic components.

For example, JP 2006-303298 A discloses a magnetic material consisting of metal nanoparticles as the magnetic material for high frequencies. The metal nanoparticles are capable of decreasing the number of magnetic domains per unit particle and reducing an eddy current loss at a high-frequency band in comparison to micrometer-order metal magnetic particles. However, even in the magnetic material disclosed in JP 2006-303298 A, when an operation frequency exceeds 1 GHz, magnetic permeability extremely decreases (refer to FIG. 2 of JP 2006-303298 A), and a magnetic loss increases.

### CITATION LIST

### Patent Document

Patent Document 1: JP 2006-303298 A

### SUMMARY OF THE INVENTION

The present disclosure has been made in consideration of such circumstances, and an object thereof is to provide a metal magnetic powder in which magnetic permeability is high and a performance index is high at a high-frequency band of a gigahertz band, and a composite magnetic body and an electronic component which include the metal magnetic powder. Note that, when the magnetic permeability is set as and a magnetic loss is set as tanδ, the performance index is expressed as μ′/tanδ.

To accomplish the object, a metal magnetic powder according to a first aspect of the present disclosure includes: Co as a main component, in which an average particle size is 1 nm to 100 nm, an X-ray diffraction chart of the metal magnetic powder has a first peak that appears in a range of a diffraction angle 2θ of 41.6±0.3°, and a second peak that appears in a range of a diffraction angle 2θ of 47.4±0.3°, and when a full width at half maximum of the first peak is set as FW1, and a full width at half maximum of the second peak is set as FW2, a ratio (FW2/FW1) of FW2 to FW1 is 1 to 5.

When the metal magnetic powder has the above-described characteristics, high magnetic permeability and a high performance index can be obtained at a high-frequency band of gigahertz band in a compatible manner.

When an integrated intensity of the first peak is set as I1, and an integrated intensity of the second peak is set as I2, a ratio (I2/I1) of I2 to I1 is preferably 1 to 10.

Preferably, the metal magnetic powder includes an additive elements including at least one of Fe, Mg, and Cu.

A metal magnetic powder according to a second aspect of the present disclosure includes: metal nanoparticles in which an average particle size (D50) is 1 nm to 100 nm, and which has a crystal phase of hcp-Co, in which when a full width at half maximum of an X-ray diffraction peak related to a (100) plane of hcp-Co is set as FW1, and a full width at half maximum of an X-ray diffraction peak related to a (101) plane of hcp-Co is set as FW2, a ratio (FW2/FW1) of FW2 to FW1 is 1 to 5.

When the metal magnetic powder has the above-described characteristics, the high magnetic permeability and the high performance index can be obtained at a high-frequency band of gigahertz band in a compatible manner.

Any of the metal magnetic powders according to the first and second aspects can be used as a material of a composite magnetic body, and the composite magnetic body includes the metal magnetic powder and a resin. The metal magnetic powder and the composite magnetic body of the present disclosure can be preferably used in electronic components such as an inductor, an antenna, and a filter which are mounted in a high-frequency circuit.

### BRIEF DESCRIPTION OF THE DRAWINGS

FIG. 1 is a schematic view illustrating a metal magnetic powder 1 according to an embodiment of the present disclosure;

FIG. 2 is a schematic view illustrating a cross-section of a composite magnetic body including the metal magnetic powder 1 illustrated in FIG. 1;

FIG. 3 is an example of an X-ray diffraction chart of the metal magnetic powder 1; and

FIG. 4 is a schematic cross-sectional view illustrating an example of an electronic component including the composite magnetic body 10 illustrated in FIG. 2.

### DETAILED DESCRIPTION OF THE PREFERRED EMBODIMENTS

Hereinafter, the present disclosure will be described in detail with reference to an embodiment illustrated in the accompanying drawings.

(Metal Magnetic Powder 1) A metal magnetic powder 1 according to this embodiment includes nanoparticles 2, and an average particle size of the nanoparticles 2 (that is, an average particle size of the metal magnetic powder 1) is 1 nm to 100 nm. The average particle size of the nanoparticles 2 can be calculated by measuring an equivalent circle diameter of each of the nanoparticles 2 by using a transmission electron microscope (TEM). Specifically, the metal magnetic powder 1 is observed by the TEM at a magnification of 500000 or more times, an area of the nanoparticle 2 included in an observation field of view is measured by image analysis software, and the equivalent circle diameter of the nanoparticle is calculated from the measurement results. At this time, it is preferable to measure the equivalent circle diameter of at least 500 or more nanoparticles 2, and a number-basis accumulative frequency distribution is obtained on the basis of the measurement results. Then, in the accumulative frequency distribution, an equivalent circle diameter in which the accumulative frequency is 50% or more is calculated as the average particle size (D50) of the nanoparticles 2.

Note that, the average particle size (D50) of the nanoparticles 2 is preferably 70 nm or less, and more preferably 50 nm or less. As the average particle size of the nanoparticles 2 is set to be smaller, a magnetic loss tanδ of the metal magnetic powder 1 tends to further decrease. The shape of the nanoparticles 2 is not particularly limited, but in a production method shown in this embodiment, typically, nanoparticles 2 having a spherical shape or a nearly spherical shape are obtained, and average circularity of the nanoparticles 2 is preferably 0.8 or more. When an area of a projection figure of each of the nanoparticles 2 is set as S, and a peripheral length of the projection figure of the nanoparticles 2 is set as L, the circularity of each of the nanoparticles 2 is expressed as 2(πS)^{1/2}/L. In addition, a coating such as an oxide coating or an insulation coating may be formed on surfaces of the nanoparticles 2.

The metal magnetic powder 1 includes cobalt (Co) as a main component. That is, the nanoparticles 2 are metal nanoparticles including Co as a main component. Note that, the “main component” represents an element occupying 80 wt % or more in the metal magnetic powder 1. The metal magnetic powder 1 preferably includes 90 wt % or more of Co, and more preferably 93 wt % or more.

In addition, the metal magnetic powder 1 preferably includes an additive elements M including at least one of Fe (iron), Mg (magnesium), and Cu (copper) other than Co (main component). Here, description of “including an additive element M” represents that a ratio of the content (wt %) of the additive element M to the content (wt %) of Co is 1 ppm or more. For example, when the ratio (Fe/Co) of the content of Fe to the content of Co is 1 ppm or more, it is determined that the metal magnetic powder 1 includes Fe, and when Fe/Co is less than 1 ppm, it is determined that the metal magnetic powder 1 does not include Fe. The presence or absence of Mg and Cu may be determined in a similar manner as in Fe.

The total content of Co, Fe, Mg, and Cu in the metal magnetic powder 1 is set as W_{T} (wt %), and the total content of Fe, Mg, and Cu in the metal magnetic powder 1 (that is, the total content of the additive element M) is set as W_{M} (wt %). In the metal magnetic powder 1 of this embodiment, a ratio of W_{M} to W_{T} (that is, (Fe+Mg+Cu)/(Co+Fe+Mg+Cu)) is preferably 10 ppm to 2000 ppm, and more preferably 10 ppm to 550 ppm. Note that, a ratio (Fe/(Co+Fe+Mg+Cu)) of the content of Fe to W_{T} is preferably 10 ppm to 550 ppm. In addition, a ratio (Mg/(Co+Fe+Mg+Cu)) of the content of Mg to W_{T} is preferably 10 ppm to 550 ppm. Similarly, a ratio (Cu/(Co+Fe+Mg+Cu)) of the content of Cu to W_{T} is preferably 10 ppm to 550 ppm.

The metal magnetic powder 1 may include other minor elements such as Cl, P, C, Si, N, and O. The total content ratio of the other minor elements in the metal magnetic powder 1 is less than 20 wt %, and preferably less than 7 wt %.

The composition (W_{T}, W_{M}, W_{M}/W_{T}, and the like) of the metal magnetic powder 1 can be measured, for example, by composition analysis using an inductively coupled plasma atomic emission spectroscopy (ICP-AES), X-ray diffraction (XRD), X-ray fluorescence analysis (XRF), energy dispersive X-ray analysis (EDS), wavelength dispersive X-ray analysis (WDS), or the like, and the ICP-AES is preferably used in the measurement. In the composition analysis by the ICP-AES, first, a sample including the metal magnetic powder 1 is taken in a glove box, and the sample is added to an acidic solution such as nitric acid (HNO₃) and is dissolved through heating. Composition analysis by the ICP-AES is performed by using the sample converted into a solution, and Co and the additive element M included in the sample may be quantified.

Note that, a main component of the metal magnetic powder 1 may be specified on the basis of X-ray diffraction analysis, or the like. For example, volume ratios of respective elements included in the metal magnetic powder 1 are calculated by X-ray diffraction analysis or the like, and an element with the highest volume may be recognized as the main component in the metal magnetic powder 1.

The metal magnetic powder 1 of this embodiment includes hcp-Co as a Co crystal phase, and may include fcc-Co and/or ϵ-Co in addition to hcp-Co. Here, hcp represents a hexagonal close packing structure, and “hcp-Co” is not an alloy phase, and represents a Co crystal phase having a hexagonal close packing structure. In addition, fcc-Co represents a Co crystal phase having a face centered cubic structure, and ϵ-Co represents a Co crystal phase having a cubic structure different from hcp and fcc. Hcp-Co is likely to be generated in bulk Co or micrometer-order Co particles, but fcc-Co and/or ϵ-Co are likely to be generated in a case where Co is fine particles having a particle size of 100 nm or less.

In the metal magnetic powder 1 of this embodiment, each of the nanoparticles 2 preferably include hcp-Co as a main phase. Here, “main phase of the nanoparticles 2 (that is, the main phase of the metal magnetic powder 1)” represents a crystal phase with a highest content ratio among hcp-Co, fcc-Co, and ϵ-Co. For example, in the metal magnetic powder 1, a ratio of hcp-Co is set as W hip , a ratio of fcc-Co is set as W_{fcc}, and a ratio of ϵ-Co is set as Wϵ, “W_{hcp}/(W_{hcp}+W_{fcc}+W_{ϵ})” representing a ratio of hcp-Co is preferably 50% or more, more preferably 70% or more, and still more preferably 80% or more. In a case where the main phase of the metal magnetic powder 1 is hcp-Co, fcc-Co and ϵ-Co may not be included in the metal magnetic powder 1, but fcc-Co and/or ϵ-Co may be included as a sub-phase of Co.

In a case where the metal magnetic powder 1 includes fcc-Co and/or ϵ-Co as a sub-phase, fcc-Co and/or ϵ-Co are preferably mixed in the nanoparticles 2 including hcp-Co as a main phase. That is, it is preferable that the metal magnetic powder 1 includes nanoparticles 2 having a mixed phase structure of Co (structure including a main phase and a sub-phase in a grain), rather than a mixture of single-phase nanoparticles consisting of hcp-Co and another single-phase nanoparticles consisting of fcc-Co or ϵ-Co. In this case, all of the nanoparticles 2 may have a mixed-phase structure, or nanoparticles 2 of hcp-Co (nanoparticles 2 which do not include the sub-phase of Co) and nanoparticles 2 having the mixed-phase structure (nanoparticles 2 including the sub-phase of Co) may be mixed. When the sub-phase of Co is included in the metal magnetic powder 1, the magnetic permeability tends to be further improved.

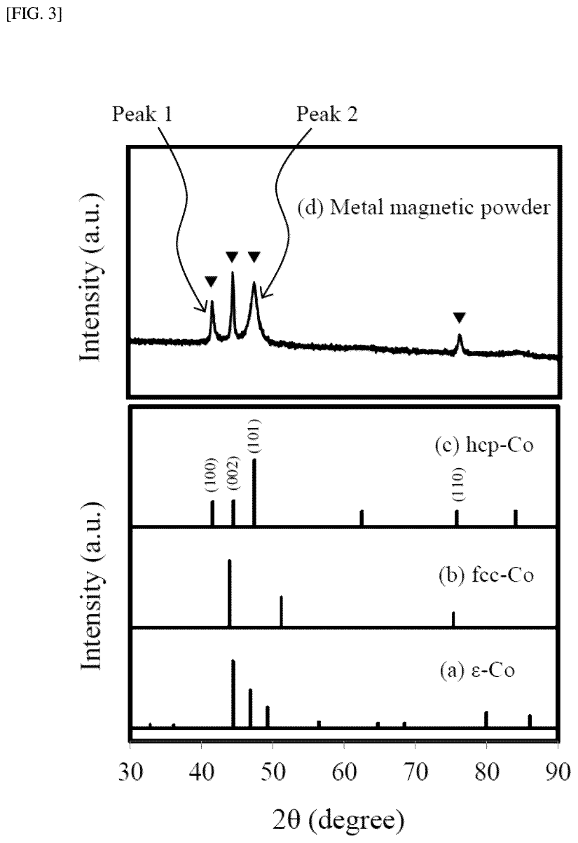

The crystal structure of the metal magnetic powder 1 (that is, the crystal structure of the nanoparticles 2) can be analyzed by X-ray diffraction (XRD). For example, (d) in FIG. 3 is an example of X-ray diffraction chart of the metal magnetic powder 1. Note that, (a) to (c) in FIG. 3 are XRD patterns recorded in a database such as a literature and ICDD, (a) is an XRD pattern of ϵ-Co, (b) is an XRD pattern of fcc-Co, and (c) is an XRD pattern of hcp-Co.

After obtaining the X-ray diffraction chart of the metal magnetic powder 1 as shown in (d) of FIG. 3 through measurement of 2θ/θ of XRD, profile fitting (peak separation) of the measured X-ray diffraction chart is performed by using analysis software for XRD. In addition, the separated diffraction peaks are compared with the database to identify a crystal phase included in the metal magnetic powder 1. In the X-ray diffraction chart (d) shown in FIG. 3, a diffraction peak appears at the same position as in the XRD pattern (c) shown in FIG. 3, and a diffraction peak indicated by “▾” shown in (d) of FIG. 3 is a peak derived from hcp-Co. In a case where the metal magnetic powder 1 includes fcc-Co and/or ϵ-Co in combination with hcp-Co, a diffraction peak appears at a position shown in (a) or (b) of FIG. 3.

A ratio of the Co crystal phase may be calculated on the basis of an integrated intensity of diffraction peaks. Specifically, after identifying diffraction peaks included in the X-ray diffraction chart by the profile fitting, the integrated intensity of the identified diffraction peaks is calculated. “W_{hcp}/(W_{hcp}+W_{fcc}+W_{ϵ})” may be calculated in a state in which Whip is set as an integrated intensity of diffraction peaks derived from hcp-Co, W_{fcc} is set as an integrated intensity of diffraction peaks derived from fcc-Co, and Wϵ is set as an integrated intensity of diffraction peaks derived from ϵ-Co.

Note that, presence or absence of the mixed phase structure in a grain of the nanoparticles 2 can be confirmed through analysis using a TEM such as a high-resolution electron microscope (HREM), electron beam backscatter diffraction (EBSD), and electron beam diffraction. For example, in a case of analyzing the crystal structure of the nanoparticles 2 by electron beam diffraction of the TEM, at least 50 nanoparticles 2 are irradiated with electron beams, and it is determined that the nanoparticles 2 have which structure between the single-phase structure and the mixed-phase structure on the basis of an electron beam diffraction pattern that is obtained at the time of the irradiation. Note that, in the analysis, it is preferable to select nanoparticles 2 isolated in a field of view and to perform irradiation with electron beams.

The X-ray diffraction chart of the metal magnetic powder 1 has at least a first peak (Peak 1 in the drawing) and a second peak (Peak 2 in the drawing) as illustrated in (d) of FIG. 3. The first peak is a peak that appears in a range of a diffraction angle 2θ of 41.6±0.3°, and a diffraction peak of a (100) plane of hcp-Co is included in the first peak. Note that, description of “peak appears in a range of 41.6±0.3°” represents that the top (peak top) of the first peak exists in a range of 41.3° to 41.9°, and a base portion of the first peak may be located outside the range. On the other hand, the second peak is a peak that appears in a range of a diffraction angle 2θ of 47.4±0.3°, and a diffraction peak of a (101) plane of hcp-Co is included in the second peak. Note that, description of “peak appears in a range of 47.4±0.3° ” represents that the top (peak top) of the second peak exists in a range of 47.1° to 47.7°, and a base portion of the second peak may be located outside the range.

In the metal magnetic powder 1 of this embodiment, when a full width at half maximum of the first peak is set as FW1, and a full width at half maximum of the second peak is set as FW2, a ratio (FW2/FW1) of FW2 to FW1 is 1 to 5. In other words, the full width at half maximum FW2 of the diffraction peak related to the (101) plane of hcp-Co is one to five times the full width at half maximum FW1 of the diffraction peak related to the (100) plane of hcp-Co, and the width of the diffraction peak of the (101) plane is preferably wider than the width of the diffraction peak of the (100) plane. When the metal magnetic powder 1 satisfies a relationship of 1 (FW2/FW1) 5, the high magnetic permeability and the low magnetic loss are compatible with each other at a high-frequency band of 1 GHz or higher, and the performance index (magnetic permeability/magnetic loss) is improved.

From the viewpoint of further reducing the magnetic loss, FW2/FW1 is preferably 1.1 to 3. On the other hand, from the viewpoint of further improving the magnetic permeability, FW2/FW1 is preferably 2 to 5. In addition, the value of the full width at half maximum FW1 of the first peak is not particularly limited, but for example, the value is preferably 1° or less, and more preferably 0.1° to 0.7°. The value of the full width at half maximum FW2 of the second peak is not particularly limited, but for example, the value is preferably 0.1° to 5°, and more preferably 0.1° to 3°.

In addition, when an integrated intensity of the first peak is set as I1, and an integrated intensity of the second peak is set as I2, in the metal magnetic powder 1 of this embodiment, a ratio (I2/I1) of I2 to I1 is preferably 1 to 10. When the metal magnetic powder 1 satisfies a relationship of 1 (I2/I1) 10, the high magnetic permeability and the low magnetic loss are more appropriately compatible with each other at a high-frequency band of 1 GHz or higher. From the viewpoint of further reducing the magnetic loss, I2/I1 is more preferably 1 to 5, and still more preferably 1 to 4. From the viewpoint of further improving the magnetic permeability, I2/I1 is more preferably 5 to 10, and still more preferably 6 to 10.

Note that, the full width at half maximum (FW1 or FW2) and the integrated intensity (I1 or I2) may be calculated by using analysis software for XRD.

The additive element M, impurities, and the like may be slightly solid-soluted in hcp-Co of the nanoparticles 2. However, the degree of deviation of a lattice constant of hcp-Co is preferably 0.5% or less. “Degree of deviation of a lattice constant” is expressed by (|d_{STD}-d_{f}|)/d_{STD} (%), and d_{STD} is a lattice constant of hcp-Co which is recorded in a database, d f is a lattice constant of hcp-Co calculated by analyzing the X-ray diffraction chart of the metal magnetic powder 1. The lattice constant may be measured by an electron beam diffraction method using a TEM.

In a case where the metal magnetic powder 1 includes the additive element M, there is a possibility that the additive element M may exist at the inside of the nanoparticles 2, on the surface of the nanoparticles 2, and at the outside of the nanoparticles 2. Note that, “outside of the nanoparticles 2” represents that the additive element M exists separately from the nanoparticles 2. For example, in a case where the metal magnetic powder 1 includes Fe and/or Cu as the additive element M, Fe and/or Cu may exist on the surface or at the outside of the nanoparticles 2, but preferably exist mainly at the inside of the nanoparticles 2. In a case where the metal magnetic powder 1 includes Mg as the additive element M, Mg may exist at the inside of the nanoparticles 2, but preferably exist on the surface of the nanoparticles 2 and/or at the outside of the nanoparticles 2.

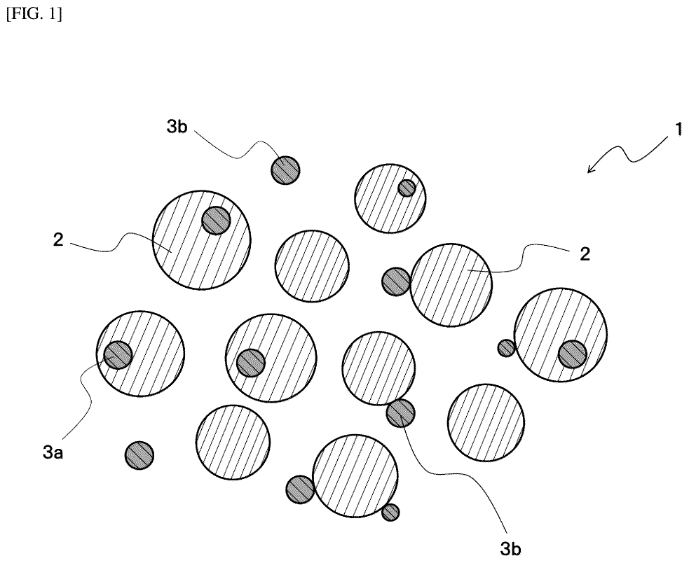

In addition, in a case where the additive element M exists at the inside of the nanoparticles 2, the additive element M is preferably included in a phase 3a different from hcp-Co rather than being solid-soluted in hcp-Co (refer to FIG. 1). Examples of the different phase 3a include a Co-Fe alloy phase having a double hexagonal crystal structure (dhcp), a Cu crystal phase having an hcp structure, a Co-Cu alloy phase, a Co compound including Mg, and the like. It is considered that the different phase 3a is generated at an initial stage of synthesis of the nanoparticles 2, and plays a role of promoting generation and growth of hcp-Co as a seed crystal.

In a case where the additive element M exists on the surface or at the outside of the nanoparticles 2, a state of the additive element M is not particularly limited. For example, as illustrated in FIG. 1, the additive element M may be included in other particles 3b. Examples of the other particles 3b include particles including an Fe compound, particles including a Cu compound, particles including a Mg compound, and the like. A particle size of the other particles 3b is not particularly limited, but the particle size is preferably smaller than the average particle size (D50) of the nanoparticles 2.

Note that, in a case where the metal magnetic powder 1 includes the additive element M, a peak derived from the additive element M may appear in the X-ray diffraction chart of the metal magnetic powder 1. Examples of the peak derived from the additive element M include a diffraction peak of Fe, a diffraction peak of a Co-Fe alloy, a diffraction peak of Cu, a diffraction peak of a Co-Cu alloy, a diffraction peak of Mg, and the like.

When analyzing the X-ray diffraction chart of the metal magnetic powder 1, in a case where the above-described diffraction peak (peak derived from the additive element M) can be separately identified as a peak different from the diffraction peak of the Co crystal phase such as hcp-Co, it can be determined that another phase 3a and/or another particle 3b including the additive element M exists in addition to the Co crystal phase. In other words, an existence state of the additive element M may be specified by an X-ray diffraction method (or an electron beam diffraction method). Note that, for example, an existence site of the additive element M can be specified by spot analysis, line analysis, or mapping analysis using TEM-EDS.

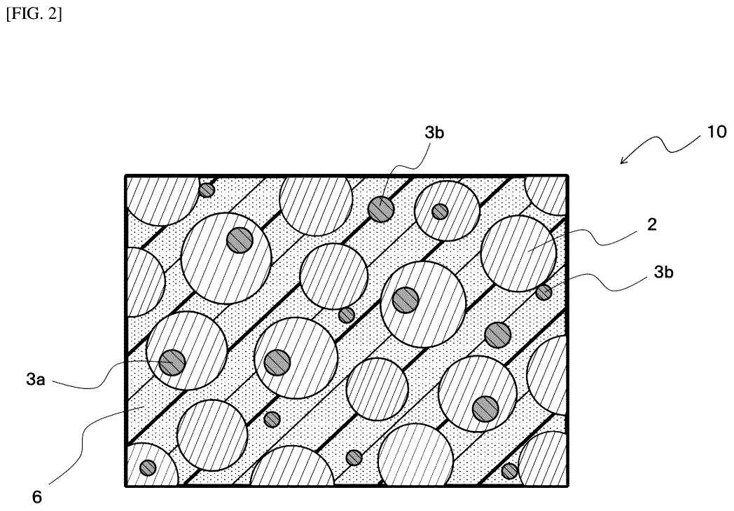

(Composite Magnetic Body 10) Next, description will be given of a composite magnetic body 10 including the above-described metal magnetic powder 1 on the basis of FIG. 2.

The composite magnetic body 10 includes the metal magnetic powder 1 having the above-described characteristics and a resin 6, and the nanoparticles 2 constituting the metal magnetic powder 1 are dispersed in the resin 6. That is, the resin 6 is interposed between the nanoparticles 2, and insulates adjacent particles. The resin 6 may be a resin material having an insulation property, and a material thereof is not particularly limited. For example, as the resin 6, thermosetting resins such as an epoxy resin, a phenolic resin, and a silicone resin, or thermoplastic resins such as an acrylic resin, polyethylene, and polypropylene can be used, and the thermosetting resins are preferable.

An area ratio of the metal magnetic powder 1 on a cross-section of the composite magnetic body 10 is preferably 10% to 60%, more preferably 5% to 40%, and still more preferably 10% to 40%.

The area ratio of the metal magnetic powder 1 on the cross-section of the composite magnetic body 10 can be calculated by observing the cross-section of the composite magnetic body 10 by using a scanning electron microscope (SEM) or a transmission electron microscope (TEM), and by analyzing a cross-sectional image by using image analysis software. Specifically, the cross-sectional image of the composite magnetic body 10 is binarized on the basis of contrast to distinguish metal magnetic powders and the other portion, and a ratio of an area occupied by the metal magnetic powder 1 with respect to the entirety of the image (that is, an area of an observation field of view) may be calculated. The area ratio calculated by the above-described method can be regarded as a volume ratio (vol %) of the metal magnetic powder 1 included in the composite magnetic body 10.

The ratio (FW2/FW1) of the full widths at half maximum and the ratio (I2/I1) of the integrated intensities may be calculated by performing measurement of 2θ/θ of XRD by using the composite magnetic body 10 as a measurement sample, and by analyzing an X-ray diffraction chart of the composite magnetic body 10. In addition, the average particle size (D50) of the metal magnetic powder 1 may be calculated by measuring an area of the nanoparticles 2 on a cross-section of the composite magnetic body 10. The composition of the metal magnetic powder 1 included in the composite magnetic body 10 (the composition of the nanoparticles 2) can be analyzed by using ICP-AES, XRD, EDS, WDS, or the like.

In a case where the metal magnetic powder 1 includes the additive element M, there is a possibility that the additive element M exists at the inside of the nanoparticles 2, on the surface of the nanoparticles 2, and at the outside of the nanoparticles 2 as described above. As illustrated in FIG. 2, it is preferable that the additive element M exists inside the composite magnetic body 10 in a similar aspect as in a powder sample (metal magnetic powder 1).

Presence or absence of the additive element M in the composite magnetic body 10 can be analyzed by using EDS, WDS, or the like. For example, with respect to at least 20 nanoparticles 2 existing on the cross-section of the composite magnetic body 10, spot analysis, line analysis, or mapping analysis by TEM-EDS is performed. In a case where the additive element M is trapped inside the composite magnetic body 10 in accordance with addition of the nanoparticles 2, the additive element M is detected at the inside and/or on the surface of the nanoparticles 2. That is, in a case where the characteristic X-ray of the additive element M is detected as a peak at the inside and/or on the surface of any nanoparticle 2 among analyzed particles, it can be determined that the metal magnetic powder 1 of the composite magnetic body 10 includes the additive element M.

Ceramic particles, metal particles other than the nanoparticles 2, and the like may be included in the composite magnetic body 10. In addition, a shape and dimensions of the composite magnetic body 10 are not particularly limited, and may be appropriately determined in accordance with the application thereof.

Hereinafter, an example of methods of manufacturing the metal magnetic powder 1 and the composite magnetic body 10 will be described.

(Method of Manufacturing Metal Magnetic Powder 1)

It is preferable that the metal magnetic powder 1 (that is, the nanoparticles 2) is manufactured by subjecting a cobalt complex as a precursor to pyrolysis in a pressurization environment. As the precursor, octacarbonyl dicobalt (Co₂(CO)₈), Co₄(CO)₁₂, chlorotris(triphenylphosphine) cobalt (CoCl(Ph₃P)₃), or the like can be used, and Co₂(CO)₈ is preferably used. In addition, in a case where the additive element M is included in the metal magnetic powder 1, an additive material including the additive element M is prepared, and the additive material and the precursor may be weighed to be a desired composition. As the additive material A, for example, chlorides such as FeCl₃, CuCl₂, MgCl₂·6H₂O, or a borohydride compound such as Mg(BH₄)₂ are preferably used. A content ratio (W_{M}/W_{T}) of the additive element M can be controlled by a blending ratio of the additive material.

Next, the raw material (the precursor, or the precursor and the additive material), and a solvent are put into a high-pressure reaction container such as an autoclave. In a typical pyrolysis method, a non-pressurization type reaction container such as a separable flask is used, but a reaction container capable of performing pressurization is used in this embodiment. As the solvent, ethanol, tetrahydrofuran (THF), oleylamine, dimethylbenzylamine, octadecyl alcohol (stearyl alcohol), or the like can be used, and dimethylbenzylamine is preferably used. Note that, a surfactant such as oleic acid and a silane coupling agent may be added to the reaction solution including the precursor.

Then, the high-pressure reaction container is installed in an oil bath, and the high-pressure reaction container is heated at a predetermined temperature for predetermined time to pyrolyze the precursor in the reaction solution. At this time, an inert gas such as Ar gas is introduced into the reaction container to set the inside of the container to an inert atmosphere, and pressurization is performed to be a predetermined pressure. The ratio (FW2/FW1) of the full widths at half maximum can be controlled by a pressure inside the reaction container, and the pressure is preferably set to 0.01 1MPa to 0.20 MPa. As the pressure inside the reaction container is further raised, the FW2/FW1 tends to further increase.

In addition, the ratio (I2/I1) of the integrated intensities can be controlled by a temperature (referred to as reaction temperature) of the pressurized reaction solution. The reaction temperature is preferably set to 52° C. to 180° C., and more preferably 55° C. to 170° C. As the reaction temperature is further raised, I2/I1 tends to further increase.

Time (referred to as reaction time) for which the reaction container is heated can be set to 0.01 hours to 110 hours, and it is preferable to appropriately adjust the reaction time in correspondence with the reaction temperature. For example, in a case where the reaction temperature is set to 52° C., the reaction time is preferably set to 1.8 hours to 110 hours, and in a case where the reaction temperature is set to 55° C., the reaction time is preferably set to 1.5 hours to 105 hours. In addition, in a case where the reaction temperature is set to 170° C., the reaction time is preferably set to 0.05 hours to 5 hours, and in a case where the reaction temperature is set to 180° C., the reaction time is preferably set to 0.01 hours to 3 hours.

The average particle size of the nanoparticles 2 (that is, the average particle size (D50) of the metal magnetic powder 1) depends on the reaction temperature and the reaction time. As the reaction temperature is further raised, the average particle size of the nanoparticles 2 tends to further increase. Similarly, as the reaction time is further lengthened, the average particle size of the nanoparticles 2 tends to further increase.

After passage of desired reaction time, the high-pressure reaction container is cooled down to room temperature, and the generated nanoparticles 2 are washed and recovered. When washing the nanoparticles 2, a washing solvent in which unreacted raw materials, an intermediate product, and the like are soluble is used. Specifically, as the washing solvent, for example, an organic solvent such as acetone, dichlorobenzene, and ethanol can be used. In order to suppress oxidation of the nanoparticles 2, it is preferable to perform a de-gassing treatment on the washing solvent. Alternatively, as the washing solvent, it is preferable to use an organic solvent with an ultra-dehydrated grade in which the content of moisture is suppressed to 10 ppm or less. Note that, the nanoparticles 2 after washing may be recovered through settlement by centrifugal separation, or may be recovered by using a magnetic force of a magnet. Through the above-described processes, the metal magnetic powder 1 is obtained.

Note that, a series of processes from weighing of the raw materials to washing and recovery of the nanoparticles are performed in an inert gas atmosphere such as an Ar atmosphere.

(Method of Manufacturing Composite Magnetic Body 10)

Next, an example of the method of manufacturing the composite magnetic body 10 will be described.

The composite magnetic body 10 can be manufactured by mixing the metal magnetic powder 1 manufactured by the pyrolysis method, the resin 6, and the solvent, and performing a predetermined dispersion treatment. As the dispersion treatment, it is preferable to use an ultrasonic dispersion treatment, or a media dispersion treatment such as a bead mill. Dispersion treatment conditions are not particularly limited, and various conditions may be set so that the nanoparticles 2 are evenly dispersed in the resin 6. As the solvent that is added at the time of the dispersion treatment, for example, organic solvents such as acetone, dichlorobenzene, or ethanol can be used, and it is preferable to use a degassed organic solvent, or an organic solvent with an ultra-dehydrated grade. In addition, as the media used at the time of the media dispersion treatment, various ceramic beads can be used, and it is preferable to use beads of ZrO₂ with large specific gravity among the various ceramic beads. Note that, the content ratio (volume ratio) of the metal magnetic powder 1 in the composite magnetic body 10 can be controlled on the basis of blending ratios of the metal magnetic powder 1 and the resin 6.

The resultant slurry obtained in the dispersion treatment is dried in an Ar atmosphere to obtain a dried body from which the solvent is volatilized. Then, the dried body is crushed by using a mortar, a dry crusher, or the like to obtain granules including the metal magnetic powder 1 and the resin 6. Then, the granules are filled in a mold and are pressurized to obtain the composite magnetic body 10. In a case of using the thermosetting resin as the resin 6, it is preferable to perform a curing treatment after the pressurization formation.

Note that, as in the manufacturing of the metal magnetic powder 1, the series of processes for obtaining the composite magnetic body 10 are performed in an inert atmosphere such as an Ar atmosphere. In addition, the method of manufacturing the composite magnetic body 10 is not limited to the pressurization formation method. For example, the slurry obtained by the dispersion treatment may be applied and dried on a PET film to obtain a sheet-shaped composite magnetic body 10.

(Summary of Embodiment)

The metal magnetic powder 1 of this embodiment is constituted by the nanoparticles 2 which include Co as a main component, and in which the average particle size (D50) is 1 nm to 100 nm. The X-ray diffraction chart of the metal magnetic powder 1 has a first peak that appears in a range of a diffraction angle 2θ of 41.6±0.3°, and a second peak that appears in a range of a diffraction angle 2θ of 47.4±0.3°. When a full width at half maximum of the first peak is set as FW1, and a full width at half maximum of the second peak is set as FW2, a ratio (FW2/FW1) of FW2 to FW1 is 1 to 5. In other words, the full width at half maximum FW2 of the X-ray diffraction peak related to the (101) plane of hcp-Co is one to five times the full width at half maximum FW1 of the X-ray diffraction peak related to the (100) plane of hcp-Co.

Since the metal magnetic powder 1 has the above-described characteristics, the high magnetic permeability and the low magnetic loss are compatible with each other and the performance index (magnetic permeability/magnetic loss) is improved not only at a megahertz band but also a high-frequency band of 1 GHz or higher. In addition, since the composite magnetic body 10 includes the metal magnetic powder 1 having the above-described characteristics, the high magnetic permeability and the low magnetic loss are compatible with each other at the high-frequency band. The reason why the high magnetic permeability and the low magnetic loss are realized is not clear, but it is considered that structural disorder of crystals contributes to the above-described effect.

Specifically, in the metal magnetic powder 1 of this embodiment, it is considered that structural disorder of crystals (particularly, hcp-Co) occurs to a certain extent satisfying a relationship of 1≤(FW2/FW1)≤5. In other words, it is considered that the full width at half maximum of the second peak is broadened due to the structure disorder of crystals. It is considered that when the structural disorder is caused to occur in crystals of the nanoparticles 2, magnetic anisotropy is slightly weakened, and an improvement of the magnetic permeability can be accomplished while maintaining the low magnetic loss.

In addition, in the X-ray diffraction chart of the metal magnetic powder 1, when an integrated intensity of the first peak is set as I1 and an integrated intensity of the second peak is set as I2, a ratio (I2/I1) of I2 to I1 is preferably 1 to 10. When the metal magnetic powder 1 satisfies a relationship of 1≤(I2/I1)≤10, the high magnetic permeability and the low magnetic loss are more appropriately compatible with each other at a high-frequency band.

In addition, the metal magnetic powder 1 preferably includes one or more kinds of additive elements M selected from Fe, Mg, and Cu. It is considered that the additive elements M play a role of promoting generation and growth of hcp-Co during manufacturing the metal magnetic powder 1. When the metal magnetic powder 1 includes a slight amount of additive element M, the magnetic loss can be further reduced.

The metal magnetic powder 1 and the composite magnetic body 10 are applicable to various electronic components such as an inductor, a transformer, a choke coil, a filter, and antenna, and are preferably applicable, particularly, to an electronic component for high-frequency circuits in which an operation frequency is 1 GHz or higher (more preferably, 1 GHz to 10 GHz).

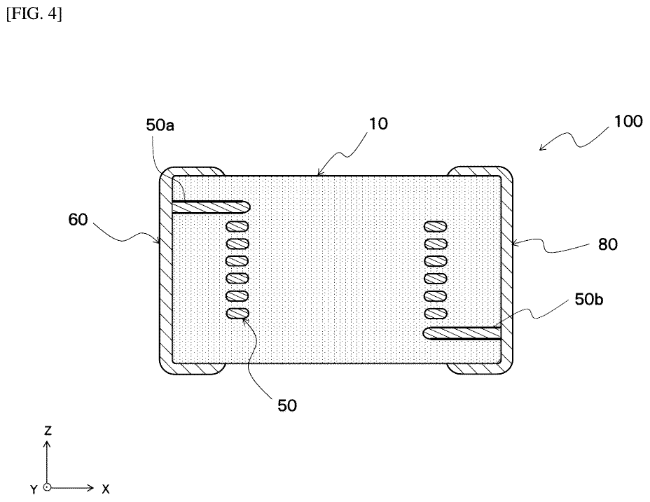

Examples of the electronic component including the metal magnetic powder 1 (or the composite magnetic body 10) include an inductor 100 illustrated in FIG. 4. An element body of the inductor 100 is constituted by the composite magnetic body 10 of this embodiment, and a coil portion 50 is embedded inside the element body. A pair of external electrodes 60 and 80 are formed on end (edge) surfaces of the element body, and the external electrodes 60 and 80 are electrically connected to leadout portions 50a and 50b of the coil portion 50, respectively. Since the electronic component such as the inductor 100 includes the metal magnetic powder 1 (the composite magnetic body 10) of this embodiment, excellent high-frequency characteristics are provided.

Hereinbefore, the embodiment of the present disclosure has been described, but the present disclosure is not limited to the above-described embodiment, and various modifications can be made within a range not departing from the gist of the present disclosure.

### EXAMPLES Hereinafter, the present disclosure will be described in more detail with reference to specific examples. However, the present invention is not limited to the following examples.

(Experiment 1)

In Experiment 1, eight kinds of metal magnetic powders shown in Table 1 were manufactured by a pyrolysis method. First, a precursor of Co and a solvent were weighed, and were put into a reaction container. CO₂(CO)₈ was used as the precursor of Co and dimethylbenzene was used as the solvent. In addition, when manufacturing the metal magnetic powder of Sample A1, a non-pressurization type separable flask was used as the reaction container, and when manufacturing the metal magnetic powder of Samples A2 to A8, a high-pressure reaction container including a gas inlet and a gas outlet was used as the reaction container. Note that, a pressure control valve and a pressure reduction valve were provided in the gas outlet of the high-pressure reaction container.

Next, the reaction container was installed in an oil bath and was heated to pyrolyze the precursor in the reaction solution. At this time, in Experiment 1, a reaction temperature was set to 57° C. and reaction time was set to three hours. In addition, in Sample A1, the oil bath and the reaction container were provided under an Ar atmosphere, and the reaction solution was stirred by using a mechanical stirrer. In Samples A2 to A8, an Ar gas was supplied from the gas inlet into the high-pressure reaction container at a constant flow rate (20 L/min), and the inside of the high-pressure reaction container was pressurized by controlling the pressure control value and the pressure reduction valve so that the inside of the high-pressure reaction container becomes a pressure shown in Table 1.

After passage of predetermined reaction time, the reaction container was left to stand, and was cooled down to room temperature. Then, generated nanoparticles were washed with ultra-dehydrated acetone, and were recovered by a magnet. Metal magnetic powders related to Samples A1 to A8 were obtained through the above-described processes. Note that, the series of working from weighting of the raw materials to washing and recovery were performed in an Ar atmosphere.

Next, composite magnetic bodies related to Sample A1 to Sample A8 were manufactured by using the metal magnetic powder.

First, the metal magnetic powder was weighed so that the content ratio of the nanoparticles in the composite magnetic body becomes 10 vol %. Then, the weighed metal magnetic powder, a polystyrene resin, and acetone as a solvent were mixed, and the resultant mixture was subjected to an ultrasonic dispersion treatment. Ultrasonic dispersion treatment time was set to 10 minutes, and a dispersion solution obtained by the ultrasonic dispersion treatment was dried in an Ar atmosphere kept at 50° C. to obtain a dried body. Then, the dried body was crushed by a mortar, and the obtained granules were filled in a mold and were pressurized to obtain a composite magnetic body. Any of the composite magnetic bodies related to Samples A1 to A8 had a toroidal shape having an outer diameter of 7 mm, an inner diameter of 3 mm, a thickness of 1 mm. Note that, respective processes of manufacturing the composite magnetic body 10 except for a formation process were performed in an Ar atmosphere.

The following evaluation was made on the respective samples in Experiment 1.

Average Particle Size of Nanoparticles

The nanoparticles manufactured by the respective samples were observed at a magnification of 500000 times by using a TEM (JEM-2100F, manufactured by JEOL Ltd.). Then, an equivalent circle diameter of 500 nanoparticles was measured by image analysis software to calculate the average particle size (D50).

Composition Analysis of Metal Magnetic Powder

A sample for composition analysis was taken from each of the composite magnetic bodies in a glove box, and the content of Co included in the sample, and the content of minor elements were measured by ICP-AES (ICPS-8100CL, manufactured by SHIMADZU CORPORATION). On the basis of the measurement results, a main component (element occupying 80 wt % or more) of the metal magnetic powder was specified, and it could be confirmed that all samples (Sample A1 to Sample A8) in Experiment 1 include Co as the main component.

Crystal Structure Analysis

An X-ray diffraction chart of the composite magnetic body was obtained through measurement of 2θ/θ by using an XRD device (Smart Lab, manufactured by Rigaku Corporation). Then, the obtained X-ray diffraction chart was analyzed by X-ray analysis integrated software (SmartLab Studio II) to calculate the full width at half maximum FW1 of the first peak (a peak that appears at 2θ of 41.6±0.3°), the full width at half maximum FW2 of the second peak (a peak that appears at 2θ of 47.4±0.3°), and a ratio (FW2/FW1 (unitless)) of the full widths at half maximum.

Note that, in the respective samples in Experiment 1, it could be confirmed that the main phase of the metal magnetic powder (main phase of the nanoparticles) is hcp-Co through structure analysis with XRD. That is, the diffraction peak of the (100) plane of hcp-Co is included in the first peak, the diffraction peak of the (101) plane of hcp-Co is included in the second peak, and FW2/FW1 shown in Table 1 can be regarded as a ratio of the full width at half maximum of the diffraction peak of the (101) plane to the full width at half maximum of the diffraction peak of the (100) plane.

Evaluation of Magnetic Characteristics

A real part (that is, magnetic permeability μ′ (unitless)) and an imaginary part μ″ of complex magnetic permeability at 5 GHz were measured by a coaxial S parameter method using a network analyzer (HP8753D, manufactured by Agilent Technologies Japan, Ltd.). Then, the magnetic loss tanδ (unitless) at 5 GHz was calculated as μ″/μ′, and the performance index (unitless) was calculated as μ′/tanδ. In this embodiment, a sample in which the magnetic permeability μ′ is 1.20 or more, and the performance index is 10 or more was determined as “satisfactory”.

Evaluation results of the respective samples in Experiment 1 are shown in Table 1.

TABLE 1

| | | Powder manufacturing conditions | | | Analysis results of metal magnetic | | | Magnetic characteristics at 5 GHz | | |
|---|---|---|---|---|---|---|---|---|---|---|
| | Example/ | Reaction | Reaction | | powder | | | Magnetic | Magnetic | |
| | Comparative | temperature | time | Pressure | Main | D50 | FW2/FW1 | permeability | loss | Performance |
| Sample No. | Example | (° C.) | (h) | (MPa) | component | (nm) | (—) | μ′ | tanδ | index |
| A1 | Comparative | 57 | 3 | 0.000 | Co | 22 | 0.9 | 1.05 | 0.068 | 15.4 |
| | Example | | | | | | | | | |
| A2 | Example | 57 | 3 | 0.010 | Co | 19 | 1.1 | 1.24 | 0.071 | 17.5 |
| A3 | Example | 57 | 3 | 0.025 | Co | 22 | 1.5 | 1.25 | 0.076 | 16.4 |
| A4 | Example | 57 | 3 | 0.050 | Co | 21 | 2.1 | 1.26 | 0.086 | 14.7 |
| A5 | Example | 57 | 3 | 0.100 | Co | 21 | 2.9 | 1.28 | 0.093 | 13.8 |
| A6 | Example | 57 | 3 | 0.150 | Co | 20 | 4.2 | 1.31 | 0.106 | 12.4 |
| A7 | Example | 57 | 3 | 0.200 | Co | 19 | 4.9 | 1.34 | 0.113 | 11.9 |
| A8 | Comparative | 57 | 3 | 0.300 | Co | 20 | 7.2 | 1.24 | 0.135 | 9.2 |
| | Example | | | | | | | | | |

As shown in Table 1, when performing pressurization during pyrolysis, it could be confirmed that the ratio (FW2/FW1) of the full widths at half maximum becomes 1.0 or more, and FW2/FW1 tends to increase in accordance with an increase in pressure. In Sample A1 (comparative example) in which FW2/FW1 is less than 1.0, the magnetic loss could be reduced, but the magnetic permeability was small and evaluation criteria of the magnetic characteristics could not be satisfied. In addition, in Sample A8 (comparative example) in which FW2/FW1 exceeds 5.0, high magnetic permeability was obtained, but the magnetic loss was large and the evaluation criteria of the magnetic characteristics could not be satisfied.

On the other hand, in Samples A2 to Sample A7 which are examples, the high magnetic permeability and the low magnetic loss were compatible with each other at 5 GHz. As a result thereof, it could be seen that when the metal magnetic powder consisting of nanocrystals of Co satisfies a relationship of 1 (FW2/FW1) 5, the magnetic permeability and the performance index can be improved at a high-frequency band in a compatible manner.

Note that, when comparing the magnetic characteristics of Sample A2 to Sample A7, it could be confirmed that as FW2/FW1 further decreases, the magnetic loss tends to be further reduced, and as FW2/FW1 further increases, the magnetic permeability tends to further increase. It could be seen that FW2/FW1 is preferably 1 to 3 from the viewpoint of further reducing the magnetic loss, and more preferably 1.0 to 2.5. In addition, it could be seen that FW2/FW1 is preferably 2 to 5 from the viewpoint of further improving the magnetic permeability, and more preferably 3 to 5.

(Experiment 2)

In Experiment 2, a plurality of metal magnetic powders different in an average particle size were manufactured under conditions shown in Table 2. Specifically, the reaction temperature at the time of pyrolysis was set to 57° C. in all samples, and the average particle size of the metal magnetic powders (nanoparticles) was controlled by changing the reaction time. Note that, manufacturing conditions other than conditions shown in Table 2 were set to be similar as in Experiment 1. In addition, composite magnetic bodies were manufactured by the same method as in Experiment 1, and magnetic characteristics thereof were measured. Evaluation results of respective samples in Experiment 2 are shown in Table 2.

TABLE 2

| | | Powder manufacturing conditions | | | | | | Magnetic characteristics at 5 GHz | | |
|---|---|---|---|---|---|---|---|---|---|---|
| | Example/ | Reaction | Reaction | | Analysis results of metal magnetic powder | | | Magnetic | Magnetic | |
| Sample | Comparative | temperature | time | Pressure | Main | D50 | FW2/FW1 | permeability | loss | Performance |
| No. | Example | (° C.) | (h) | (MPa) | component | (nm) | (—) | μ′ | tanδ | index |
| B1 | Comparative | 57 | 1 | 0.000 | Co | 2 | 0.9 | 1.03 | 0.067 | 15.4 |
| | Example | | | | | | | | | |
| A1 | Comparative | 57 | 3 | 0.000 | Co | 22 | 0.9 | 1.05 | 0.068 | 15.4 |
| | Example | | | | | | | | | |
| B2 | Comparative | 57 | 12 | 0.000 | Co | 48 | 0.8 | 1.08 | 0.069 | 15.7 |
| | Example | | | | | | | | | |
| B3 | Comparative | 57 | 96 | 0.000 | Co | 98 | 0.9 | 1.12 | 0.072 | 15.6 |
| | Example | | | | | | | | | |
| B4 | Comparative | 57 | 120 | 0.000 | Co | 120 | 0.9 | 1.08 | 0.130 | 8.3 |
| | Example | | | | | | | | | |
| B5 | Example | 57 | 1 | 0.010 | Co | 3 | 1.1 | 1.22 | 0.070 | 17.4 |
| A2 | Example | 57 | 3 | 0.010 | Co | 19 | 1.1 | 1.24 | 0.071 | 17.5 |
| B6 | Example | 57 | 12 | 0.010 | Co | 50 | 1.1 | 1.26 | 0.072 | 17.5 |
| B7 | Example | 57 | 96 | 0.010 | Co | 99 | 1.1 | 1.29 | 0.075 | 17.2 |
| B8 | Comparative | 57 | 120 | 0.010 | Co | 122 | 1.1 | 1.15 | 0.122 | 9.4 |
| | Example | | | | | | | | | |
| B9 | Example | 57 | 1 | 0.025 | Co | 2 | 1.7 | 1.22 | 0.074 | 16.5 |
| A3 | Example | 57 | 3 | 0.025 | Co | 22 | 1.5 | 1.25 | 0.076 | 16.4 |
| B10 | Example | 57 | 12 | 0.025 | Co | 48 | 1.7 | 1.28 | 0.078 | 16.4 |
| B11 | Example | 57 | 96 | 0.025 | Co | 100 | 1.3 | 1.31 | 0.082 | 16.0 |
| B12 | Comparative | 57 | 120 | 0.025 | Co | 120 | 1.3 | 1.18 | 0.126 | 9.4 |
| | Example | | | | | | | | | |
| B13 | Example | 57 | 1 | 0.050 | Co | 3 | 2.0 | 1.24 | 0.085 | 14.6 |
| A4 | Example | 57 | 3 | 0.050 | Co | 21 | 2.1 | 1.26 | 0.086 | 14.7 |
| B14 | Example | 57 | 12 | 0.050 | Co | 49 | 2.2 | 1.29 | 0.087 | 14.8 |
| B15 | Example | 57 | 96 | 0.050 | Co | 98 | 2.1 | 1.33 | 0.089 | 14.9 |
| B16 | Comparative | 57 | 120 | 0.050 | Co | 121 | 2.0 | 1.22 | 0.131 | 9.3 |
| | Example | | | | | | | | | |
| B17 | Example | 57 | 1 | 0.100 | Co | 2 | 2.8 | 1.27 | 0.091 | 14.0 |
| A5 | Example | 57 | 3 | 0.100 | Co | 21 | 2.9 | 1.28 | 0.093 | 13.8 |
| B18 | Example | 57 | 12 | 0.100 | Co | 49 | 3.1 | 1.31 | 0.095 | 13.8 |
| B19 | Example | 57 | 96 | 0.100 | Co | 98 | 3.0 | 1.34 | 0.097 | 13.8 |
| B20 | Comparative | 57 | 120 | 0.100 | Co | 120 | 3.2 | 1.24 | 0.135 | 9.2 |
| | Example | | | | | | | | | |
| B21 | Example | 57 | 1 | 0.150 | Co | 2 | 3.8 | 1.29 | 0.102 | 12.6 |
| A6 | Example | 57 | 3 | 0.150 | Co | 20 | 4.2 | 1.31 | 0.106 | 12.4 |
| B22 | Example | 57 | 12 | 0.150 | Co | 51 | 4.1 | 1.34 | 0.107 | 12.5 |
| B23 | Example | 57 | 96 | 0.150 | Co | 97 | 4.1 | 1.37 | 0.111 | 12.3 |
| B24 | Comparative | 57 | 120 | 0.150 | Co | 122 | 3.8 | 1.30 | 0.142 | 9.2 |
| | Example | | | | | | | | | |
| B25 | Example | 57 | 1 | 0.200 | Co | 3 | 5.0 | 1.33 | 0.110 | 12.1 |
| A7 | Example | 57 | 3 | 0.200 | Co | 19 | 4.9 | 1.34 | 0.113 | 11.9 |
| B26 | Example | 57 | 12 | 0.200 | Co | 49 | 4.9 | 1.36 | 0.115 | 11.8 |
| B27 | Example | 57 | 96 | 0.200 | Co | 97 | 4.9 | 1.40 | 0.125 | 11.2 |
| B28 | Comparative | 57 | 120 | 0.200 | Co | 118 | 4.9 | 1.32 | 0.143 | 9.2 |
| | Example | | | | | | | | | |
| B29 | Comparative | 57 | 1 | 0.300 | Co | 2 | 7.1 | 1.21 | 0.132 | 9.2 |
| | Example | | | | | | | | | |
| A8 | Comparative | 57 | 3 | 0.300 | Co | 20 | 7.2 | 1.24 | 0.135 | 9.2 |
| | Example | | | | | | | | | |
| B30 | Comparative | 57 | 12 | 0.300 | Co | 52 | 6.9 | 1.25 | 0.137 | 9.1 |
| | Example | | | | | | | | | |
| B31 | Comparative | 57 | 96 | 0.300 | Co | 99 | 6.9 | 1.27 | 0.140 | 9.1 |
| | Example | | | | | | | | | |
| B32 | Comparative | 57 | 120 | 0.300 | Co | 119 | 7.0 | 1.22 | 0.155 | 7.9 |
| | Example | | | | | | | | | |

As shown in Table 2, it could be seen that the ratio (FW2/FW1) of the full widths at half maximum depends on the pressure at the time of pyrolysis, and FW2/FW1 hardly varies even when changing the reaction time. It could be confirmed that the reaction time has an influence on the average particle size of the nanoparticles, and as the reaction time is further lengthened, the average particle size tends to further increase.

In addition, from the evaluation results in Table 2, it could be confirmed that when decreasing the average particle size, the magnetic loss tends to be reduced. It is considered that when decreasing the average particle size, the number of magnetic domains included in the nanoparticles decreases, and an eddy current loss can be suppressed. On the other hand, it could be confirmed that when increasing the average particle size, the magnetic permeability tends to be improved. However, when the average particle size became larger than 100 nm, even in Samples (Samples B8, B12, B16, B20, B24, and B28) satisfying a relationship of 1 (FW2/FW1) 5, the magnetic loss increased, the magnetic permeability decreased, and the evaluation criteria of the magnetic characteristics could not be satisfied. From the results, it could be seen that the average particle size of the Co nanoparticles should be set to 1 nm to 100 nm, and when the metal magnetic powder having the average particle size of 1 nm to 100 nm satisfies the relationship of 1 (FW2/FW1) 5, the magnetic permeability and the performance index can be improved in a compatible manner.

(Experiment 3) In Experiment 3, a plurality of metal magnetic powders different in a ratio (I2/I1) of an integrated intensity were manufactured under conditions shown in Table 3 and Table 4. Specifically, in Experiment 3, the reaction temperature at the time of pyrolysis was changed in accordance with samples, and I2/I1 in the respective samples was controlled by the reaction temperature. Note that, the reaction time at the time of pyrolysis was adjusted in correspondence with the reaction temperature so that the average particle size of the nanoparticles becomes 20±2 nm. Metal magnetic powders and composite magnetic bodies related to the respective samples were manufactured by setting manufacturing conditions other than conditions shown in Table 3 and Table 4 to be similar as in Experiment 1. Table 3 shows evaluation results of samples for which I2/I1 was changed while controlling FW2/FW1 within a range of 2.0±0.2, and Table 4 shows evaluation results for which FW2/FW1 and 12/I1 were changed.

The ratio (I2/I1) (unitless) of the integrated intensity was calculated by analyzing an X-ray diffraction chart of each of the composite magnetic bodies with X-ray analysis integrated software, and by measuring the integrated intensity I1 of the first peak and the integrated intensity I2 of the second peak.

TABLE 3

| | | Powder manufacturing conditions | | | | | | | Magnetic characteristics at 5 GHz | | |
|---|---|---|---|---|---|---|---|---|---|---|---|
| | Example/ | Reaction | Reaction | | Analysis results of metal magnetic powder | | | | Magnetic | | |
| Sample | Comparative | temperature | time | Pressure | Main | D50 | FW2/FW1 | I2/I1 | permeability | Magnetic loss | Performance |
| No. | Example | (° C.) | (h) | (MPa) | component | (nm) | (—) | (—) | μ′ | tanδ | index |
| C1 | Example | 55 | 4.0 | 0.050 | Co | 21 | 2.0 | 1.0 | 1.24 | 0.084 | 14.8 |
| A4 | Example | 57 | 3.0 | 0.050 | Co | 21 | 2.1 | 1.3 | 1.26 | 0.086 | 14.7 |
| C2 | Example | 65 | 2.5 | 0.050 | Co | 22 | 2.1 | 1.9 | 1.26 | 0.088 | 14.3 |
| C3 | Example | 80 | 2.2 | 0.050 | Co | 20 | 2.0 | 3.0 | 1.27 | 0.090 | 14.1 |
| C4 | Example | 120 | 1.8 | 0.050 | Co | 19 | 2.2 | 6.0 | 1.28 | 0.092 | 13.9 |
| C5 | Example | 150 | 1.5 | 0.050 | Co | 22 | 2.0 | 7.5 | 1.29 | 0.094 | 13.7 |
| C6 | Example | 170 | 1.0 | 0.050 | Co | 21 | 1.8 | 10.0 | 1.30 | 0.095 | 13.7 |
| C7 | Example | 52 | 5.0 | 0.050 | Co | 20 | 2.1 | 0.9 | 1.24 | 0.087 | 14.3 |
| C8 | Example | 180 | 0.8 | 0.050 | Co | 21 | 1.9 | 10.4 | 1.26 | 0.099 | 12.7 |

TABLE 4

| | | Powder manufacturing conditions | | | | | | | Magnetic characteristics at 5 GHz | | |
|---|---|---|---|---|---|---|---|---|---|---|---|
| | Example/ | Reaction | Reaction | | Analysis results of metal magnetic powder | | | | Magnetic | Magnetic | |
| Sample | Comparative | temperature | time | Pressure | Main | D50 | FW2/FW1 | I2/I1 | permeability | loss | Performance |
| No. | Example | (° C.) | (h) | (MPa) | component | (nm) | (—) | (—) | μ′ | tanδ | index |
| D19 | Example | 52 | 5.0 | 0.010 | Co | 19 | 1.1 | 0.9 | 1.22 | 0.072 | 16.9 |
| D1 | Example | 55 | 4.0 | 0.010 | Co | 18 | 1.1 | 1.0 | 1.22 | 0.068 | 17.9 |
| A2 | Example | 57 | 3.0 | 0.010 | Co | 19 | 1.1 | 1.5 | 1.24 | 0.071 | 17.5 |
| D2 | Example | 65 | 2.5 | 0.010 | Co | 21 | 1.2 | 2.0 | 1.24 | 0.072 | 17.2 |
| D3 | Example | 80 | 2.2 | 0.010 | Co | 19 | 1.1 | 3.2 | 1.25 | 0.072 | 17.4 |
| D4 | Example | 120 | 1.8 | 0.010 | Co | 21 | 1.3 | 6.0 | 1.25 | 0.073 | 17.1 |
| D5 | Example | 150 | 1.5 | 0.010 | Co | 21 | 1.2 | 7.7 | 1.25 | 0.077 | 16.2 |
| D6 | Example | 170 | 1.0 | 0.010 | Co | 19 | 1.1 | 9.7 | 1.26 | 0.080 | 15.8 |
| D20 | Example | 180 | 0.8 | 0.010 | Co | 20 | 1.2 | 10.3 | 1.24 | 0.085 | 14.6 |
| C7 | Example | 52 | 5.0 | 0.050 | Co | 20 | 2.1 | 0.9 | 1.24 | 0.087 | 14.3 |
| C1 | Example | 55 | 4.0 | 0.050 | Co | 21 | 2.0 | 1.0 | 1.24 | 0.084 | 14.8 |
| A4 | Example | 57 | 3.0 | 0.050 | Co | 21 | 2.1 | 1.3 | 1.26 | 0.086 | 14.7 |
| C2 | Example | 65 | 2.5 | 0.050 | Co | 22 | 2.1 | 1.9 | 1.26 | 0.088 | 14.3 |
| C3 | Example | 80 | 2.2 | 0.050 | Co | 20 | 2.0 | 3.0 | 1.27 | 0.090 | 14.1 |
| C4 | Example | 120 | 1.8 | 0.050 | Co | 19 | 2.2 | 6.0 | 1.28 | 0.092 | 13.9 |
| C5 | Example | 150 | 1.5 | 0.050 | Co | 22 | 2.0 | 7.5 | 1.29 | 0.094 | 13.7 |
| C6 | Example | 170 | 1.0 | 0.050 | Co | 21 | 1.8 | 10.0 | 1.30 | 0.095 | 13.7 |
| C8 | Example | 180 | 0.8 | 0.050 | Co | 21 | 1.9 | 10.4 | 1.26 | 0.099 | 12.7 |
| D21 | Example | 52 | 5.0 | 0.100 | Co | 20 | 3.0 | 0.8 | 1.26 | 0.093 | 13.5 |
| D7 | Example | 55 | 4.0 | 0.100 | Co | 19 | 3.1 | 1.2 | 1.26 | 0.090 | 14.0 |
| A5 | Example | 57 | 3.0 | 0.100 | Co | 21 | 2.9 | 1.6 | 1.28 | 0.093 | 13.8 |
| D8 | Example | 65 | 2.5 | 0.100 | Co | 19 | 2.9 | 1.9 | 1.29 | 0.095 | 13.6 |
| D9 | Example | 80 | 2.2 | 0.100 | Co | 21 | 2.9 | 2.8 | 1.31 | 0.098 | 13.4 |
| D10 | Example | 120 | 1.8 | 0.100 | Co | 21 | 2.9 | 6.2 | 1.34 | 0.102 | 13.1 |
| D11 | Example | 150 | 1.5 | 0.100 | Co | 20 | 3.2 | 7.6 | 1.36 | 0.104 | 13.1 |
| D12 | Example | 170 | 1.0 | 0.100 | Co | 20 | 3.2 | 9.8 | 1.38 | 0.108 | 12.8 |
| D22 | Example | 180 | 0.8 | 0.100 | Co | 20 | 3.1 | 10.5 | 1.32 | 0.120 | 11.0 |
| D23 | Example | 52 | 5.0 | 0.200 | Co | 21 | 4.9 | 0.9 | 1.31 | 0.122 | 10.7 |
| D13 | Example | 55 | 4.0 | 0.200 | Co | 22 | 5.0 | 1.2 | 1.32 | 0.109 | 12.1 |
| A7 | Example | 57 | 3.0 | 0.200 | Co | 19 | 4.9 | 1.4 | 1.34 | 0.113 | 11.9 |
| D14 | Example | 65 | 2.5 | 0.200 | Co | 21 | 4.7 | 2.1 | 1.35 | 0.117 | 11.5 |
| D15 | Example | 80 | 2.2 | 0.200 | Co | 21 | 5.0 | 3.0 | 1.37 | 0.119 | 11.5 |
| D16 | Example | 120 | 1.8 | 0.200 | Co | 22 | 4.9 | 6.1 | 1.38 | 0.122 | 11.3 |
| D17 | Example | 150 | 1.5 | 0.200 | Co | 20 | 4.7 | 7.7 | 1.39 | 0.123 | 11.3 |
| D18 | Example | 170 | 1.0 | 0.200 | Co | 20 | 4.8 | 9.9 | 1.41 | 0.124 | 11.4 |
| D24 | Example | 180 | 0.8 | 0.200 | Co | 20 | 4.9 | 10.3 | 1.36 | 0.134 | 10.1 |

As shown in Table 3, in Examples (for example, Sample C1 to Sample C6, and Sample A4 in Table 3) satisfying a relationship of 1 (I2/I1) 10, higher magnetic permeability was obtained in comparison to Sample C7 in which I2/I1 is less than 1, and the magnetic loss could be further reduced (the performance index could be further improved) in comparison to Sample C8 in which I2/I1 exceeds 10. From the results, it could be seen that I2/I1 is preferably 1 to 10.

In addition, in Examples (Sample C1 to Sample C6, and Sample A4) shown in Table 3, values of FW2/FW1 are approximately the same as each other, but values of I2/I1 are different from each other, and thus it could be seen that the magnetic characteristics vary in correspondence with I2/I1. Specifically, from the results in Table 3, it could be confirmed that as I2/I1 is smaller, the magnetic loss tends to be further reduced, and it could be confirmed that as I2/I1 is larger, the magnetic permeability tends to further increase. It could be seen that I2/I1 is 1 to 5 from the viewpoint of further reducing the magnetic loss, and more preferably 1 to 3. In addition, it could be seen that I2/I1 is preferably 5 to 10 from the viewpoint of further improving the magnetic permeability, and more preferably 6 to 10.

Note that, as shown in Table 3 and Table 4, it could be seen that the ratio (FW2/FW1) of the full widths at half maximum hardly varies even when changing the reaction temperature. On the other hand, it could be confirmed that the ratio (I2/I1) of the integrated intensities depends on the temperature of the pressurized reaction solution, and when raising the reaction temperature in a pressurizing environment, I2/I1 tends to increase. As described above, it could be seen that FW2/FW1 and I2/I1 can be controlled by different factors, and when combining control of FW2/FW1 and control of I2/I1, the magnetic permeability characteristics and the magnetic loss characteristics can be further improved.

For example, in examples shown in Table 4, the magnetic loss of Sample D1 was the lowest (the performance index of Sample D1 was highest), and the magnetic permeability of Sample D18 was the highest. That is, in a case of making any of FW2/FW1 and I2/I1 small, the magnetic loss could be further reduced in comparison to other examples, and in a case of making any of FW2/FW1 and I2/I1 larger, the magnetic permeability could be further improved in comparison to other examples.

As described above with reference to the evaluation results in Experiment 1, when making FW2/FW1 small, the magnetic permeability tends to be reduced. On the other hand, in examples shown in Table 4, in Sample C6 in which FW2/FW1 is 1.8, similar magnetic permeability as in Sample D13 in which FW2/FW1 is 5.0 was obtained. That is, even in a case of making FW2/FW1 small (for example, 2 or less), it could be seen that when making I2/I1 large, the magnetic permeability can be further improved.

With regard to the magnetic loss, the same tendency as described above could be confirmed. As shown in Table 3, when making I2/I1 large, the magnetic loss tended to increase. However, in examples shown in Table 4, in Sample D6 in which I2/I1 is 9.7, the magnetic loss could be further reduced in comparison to Sample D13 in which I2/I1 is 1.2. That is, even in a case of making I2/I1 large (for example, 6 or more), it could be seen that when making FW2/FW1 small, the magnetic loss could be further reduced.

As described above, it could be seen that the high magnetic permeability and the low magnetic loss are more appropriately compatible with each other at a high-frequency band by controlling not only FW2/FW1 but also 12/I1.

(Experiment 4)

In Experiment 4, a plurality of metal magnetic powders different in the average particle size and I2/I1, and composite magnetic bodies were manufactured under conditions shown in Table 5 to Table 7. Specifically, in examples shown in Table 5, the metal magnetic powders were manufactured by setting the pressure at the time of pyrolysis to 0.01 MPa and by changing the reaction temperature and the reaction time. In examples shown in Table 6, the metal magnetic powders were manufactured by setting the pressure at the time of pyrolysis to 0.05 MPa and by changing the reaction temperature and the reaction time. In addition, in examples shown in Table 7, the metal magnetic powders were manufactured by setting the pressure at the time of pyrolysis to 0.20 MPa and by changing the reaction temperature and the reaction time. Manufacturing conditions other than the conditions shown in Table 5 to Table 7 were set to be similar as in Experiment 1, and the magnetic characteristics of the composite magnetic bodies related to the respective examples were evaluated.

TABLE 5

| | | Powder manufacturing conditions | | | | | | | Magnetic characteristics at 5 GHz | | |
|---|---|---|---|---|---|---|---|---|---|---|---|
| | Example/ | Reaction | Reaction | | Analysis results of metal magnetic powder | | | | Magnetic | Magnetic | |
| Sample | Comparative | temperature | time | Pressure | Main | D50 | FW2/FW1 | I2/I1 | permeability | loss | Performance |
| No. | Example | (° C.) | (h) | (MPa) | component | (nm) | (—) | (—) | μ′ | tanδ | index |
| E12 | Example | 52 | 1.8 | 0.010 | Co | 3 | 1.2 | 0.8 | 1.21 | 0.071 | 17.0 |
| D19 | Example | 52 | 5 | 0.010 | Co | 19 | 1.1 | 0.9 | 1.22 | 0.072 | 16.9 |
| E13 | Example | 52 | 18 | 0.010 | Co | 52 | 1.2 | 0.9 | 1.24 | 0.074 | 16.8 |
| E14 | Example | 52 | 35 | 0.010 | Co | 70 | 1.1 | 0.8 | 1.25 | 0.077 | 16.2 |
| E15 | Example | 52 | 110 | 0.010 | Co | 97 | 1.2 | 0.9 | 1.26 | 0.079 | 15.9 |
| E1 | Example | 55 | 1.5 | 0.010 | Co | 2 | 1.3 | 1.0 | 1.21 | 0.067 | 18.1 |
| D1 | Example | 55 | 4 | 0.010 | Co | 18 | 1.1 | 1.0 | 1.22 | 0.068 | 17.9 |
| E2 | Example | 55 | 15 | 0.010 | Co | 48 | 1.3 | 1.2 | 1.24 | 0.070 | 17.7 |
| E3 | Example | 55 | 30 | 0.010 | Co | 72 | 1.1 | 1.1 | 1.25 | 0.073 | 17.1 |
| E4 | Example | 55 | 105 | 0.010 | Co | 100 | 1.1 | 1.0 | 1.26 | 0.074 | 17.0 |
| B5 | Example | 57 | 1 | 0.010 | Co | 3 | 1.1 | 1.6 | 1.22 | 0.070 | 17.4 |
| A2 | Example | 57 | 3 | 0.010 | Co | 19 | 1.1 | 1.5 | 1.24 | 0.071 | 17.5 |
| B6 | Example | 57 | 12 | 0.010 | Co | 50 | 1.1 | 1.4 | 1.26 | 0.072 | 17.5 |
| E5 | Example | 57 | 24 | 0.010 | Co | 68 | 1.3 | 1.5 | 1.27 | 0.073 | 17.4 |
| B7 | Example | 57 | 96 | 0.010 | Co | 99 | 1.1 | 1.4 | 1.29 | 0.075 | 17.2 |
| E6 | Example | 120 | 0.1 | 0.010 | Co | 2 | 1.0 | 6.2 | 1.24 | 0.072 | 17.2 |
| D4 | Example | 120 | 1.8 | 0.010 | Co | 21 | 1.3 | 6.0 | 1.25 | 0.073 | 17.1 |
| E7 | Example | 120 | 5 | 0.010 | Co | 50 | 1.3 | 5.6 | 1.27 | 0.076 | 16.7 |
| E8 | Example | 120 | 8 | 0.010 | Co | 72 | 1.3 | 5.8 | 1.29 | 0.080 | 16.1 |
| E9 | Example | 170 | 0.05 | 0.010 | Co | 3 | 1.2 | 10.0 | 1.25 | 0.077 | 16.2 |
| D6 | Example | 170 | 1 | 0.010 | Co | 19 | 1.1 | 9.7 | 1.26 | 0.080 | 15.8 |
| E10 | Example | 170 | 3 | 0.010 | Co | 48 | 1.3 | 9.8 | 1.28 | 0.081 | 15.8 |
| E11 | Example | 170 | 5 | 0.010 | Co | 71 | 1.5 | 9.6 | 1.30 | 0.085 | 15.3 |
| E16 | Example | 180 | 0.01 | 0.010 | Co | 3 | 1.1 | 10.2 | 1.22 | 0.082 | 14.9 |
| D20 | Example | 180 | 0.8 | 0.010 | Co | 20 | 1.2 | 10.3 | 1.24 | 0.085 | 14.6 |
| E17 | Example | 180 | 2 | 0.010 | Co | 51 | 1.2 | 10.2 | 1.26 | 0.088 | 14.3 |
| E18 | Example | 180 | 3 | 0.010 | Co | 69 | 1.4 | 10.4 | 1.27 | 0.093 | 13.7 |

TABLE 6

| | | Powder manufacturing conditions | | | | | | | Magnetic characteristics at 5 GHz | | |
|---|---|---|---|---|---|---|---|---|---|---|---|
| | Example/ | Reaction | Reaction | | Analysis results of metal magnetic powder | | | | Magnetic | Magnetic | |
| | Comparative | temperature | time | Pressure | Main | D50 | FW2/FW1 | I2/I1 | permeability | loss | Performance |
| Sample No. | Example | (° C.) | (h) | (MPa) | component | (nm) | (—) | (—) | μ′ | tanδ | index |
| F12 | Example | 52 | 1.8 | 0.050 | Co | 2 | 2.1 | 0.8 | 1.23 | 0.086 | 14.3 |
| C7 | Example | 52 | 5 | 0.050 | Co | 20 | 2.1 | 0.9 | 1.24 | 0.087 | 14.3 |
| F13 | Example | 52 | 18 | 0.050 | Co | 48 | 1.9 | 0.9 | 1.26 | 0.087 | 14.5 |
| F14 | Example | 52 | 35 | 0.050 | Co | 69 | 2.0 | 0.9 | 1.28 | 0.088 | 14.5 |
| F15 | Example | 52 | 110 | 0.050 | Co | 99 | 1.9 | 0.8 | 1.31 | 0.088 | 14.9 |
| F1 | Example | 55 | 1.5 | 0.050 | Co | 3 | 1.9 | 1.2 | 1.23 | 0.083 | 14.8 |
| C1 | Example | 55 | 4 | 0.050 | Co | 21 | 2.0 | 1.0 | 1.24 | 0.084 | 14.8 |
| F2 | Example | 55 | 15 | 0.050 | Co | 50 | 2.1 | 1.2 | 1.26 | 0.085 | 14.8 |
| F3 | Example | 55 | 30 | 0.050 | Co | 71 | 1.9 | 1.1 | 1.28 | 0.086 | 14.9 |
| F4 | Example | 55 | 105 | 0.050 | Co | 98 | 1.9 | 1.1 | 1.31 | 0.087 | 15.1 |
| B13 | Example | 57 | 1 | 0.050 | Co | 3 | 2.0 | 1.5 | 1.24 | 0.085 | 14.6 |
| A4 | Example | 57 | 3 | 0.050 | Co | 21 | 2.1 | 1.3 | 1.26 | 0.086 | 14.7 |
| B14 | Example | 57 | 12 | 0.050 | Co | 49 | 2.2 | 1.7 | 1.29 | 0.087 | 14.8 |
| F5 | Example | 57 | 24 | 0.050 | Co | 72 | 1.9 | 1.5 | 1.30 | 0.088 | 14.8 |
| B15 | Example | 57 | 96 | 0.050 | Co | 98 | 2.1 | 1.5 | 1.33 | 0.089 | 14.9 |
| F6 | Example | 120 | 0.1 | 0.050 | Co | 2 | 2.2 | 6.0 | 1.27 | 0.090 | 14.1 |
| C4 | Example | 120 | 1.8 | 0.050 | Co | 19 | 2.2 | 6.0 | 1.28 | 0.092 | 13.9 |
| F7 | Example | 120 | 5 | 0.050 | Co | 50 | 2.0 | 5.7 | 1.31 | 0.094 | 13.9 |
| F8 | Example | 120 | 8 | 0.050 | Co | 69 | 2.0 | 6.0 | 1.34 | 0.094 | 14.3 |
| F9 | Example | 170 | 0.05 | 0.050 | Co | 3 | 2.0 | 9.7 | 1.28 | 0.091 | 14.1 |
| C6 | Example | 170 | 1 | 0.050 | Co | 21 | 1.8 | 10.0 | 1.30 | 0.095 | 13.7 |
| F10 | Example | 170 | 3 | 0.050 | Co | 52 | 1.8 | 9.8 | 1.33 | 0.096 | 13.9 |
| F11 | Example | 170 | 5 | 0.050 | Co | 69 | 2.0 | 9.8 | 1.35 | 0.098 | 13.8 |
| F16 | Example | 180 | 0.01 | 0.050 | Co | 5 | 2.3 | 10.3 | 1.25 | 0.095 | 13.2 |
| C8 | Example | 180 | 0.8 | 0.050 | Co | 21 | 1.9 | 10.4 | 1.26 | 0.099 | 12.7 |
| F17 | Example | 180 | 2 | 0.050 | Co | 52 | 1.9 | 10.2 | 1.28 | 0.100 | 12.8 |
| F18 | Example | 180 | 3 | 0.050 | Co | 73 | 2.1 | 10.1 | 1.30 | 0.102 | 12.7 |

TABLE 7

| | | Powder manufacturing conditions | | | | | | | Magnetic characteristics at 5 GHz | | |
|---|---|---|---|---|---|---|---|---|---|---|---|
| | Example/ | Reaction | Reaction | | Analysis results of metal magnetic powder | | | | Magnetic | Magnetic | |
| Sample | Comparative | temperature | time | Pressure | Main | D50 | FW2/FW1 | I2/I1 | permeability | loss | Performance |
| No. | Example | (° C.) | (h) | (MPa) | component | (nm) | (—) | (—) | μ′ | tanδ | index |
| G12 | Example | 52 | 1.8 | 0.200 | Co | 3 | 4.8 | 0.8 | 1.30 | 0.118 | 11.0 |
| D23 | Example | 52 | 5.0 | 0.200 | Co | 21 | 4.9 | 0.9 | 1.31 | 0.122 | 10.7 |
| G13 | Example | 52 | 18 | 0.200 | Co | 49 | 5.0 | 0.9 | 1.34 | 0.124 | 10.8 |
| G14 | Example | 52 | 35 | 0.200 | Co | 70 | 5.0 | 0.7 | 1.38 | 0.127 | 10.9 |
| G15 | Example | 52 | 110 | 0.200 | Co | 97 | 4.8 | 0.8 | 1.39 | 0.128 | 10.9 |
| G1 | Example | 55 | 1.5 | 0.200 | Co | 2 | 5.0 | 1.2 | 1.30 | 0.107 | 12.1 |
| D13 | Example | 55 | 4 | 0.200 | Co | 22 | 5.0 | 1.2 | 1.32 | 0.109 | 12.1 |
| G2 | Example | 55 | 15 | 0.200 | Co | 48 | 4.9 | 1.2 | 1.34 | 0.112 | 12.0 |
| G3 | Example | 55 | 30 | 0.200 | Co | 72 | 4.8 | 1.0 | 1.38 | 0.115 | 12.0 |
| G4 | Example | 55 | 105 | 0.200 | Co | 98 | 5.0 | 1.2 | 1.40 | 0.119 | 11.8 |
| B25 | Example | 57 | 1 | 0.200 | Co | 3 | 5.0 | 1.4 | 1.33 | 0.110 | 12.1 |
| A7 | Example | 57 | 3 | 0.200 | Co | 19 | 4.9 | 1.4 | 1.34 | 0.113 | 11.9 |
| B26 | Example | 57 | 12 | 0.200 | Co | 49 | 4.9 | 1.5 | 1.36 | 0.115 | 11.8 |
| G5 | Example | 57 | 24 | 0.200 | Co | 68 | 4.8 | 1.7 | 1.38 | 0.120 | 11.5 |
| B27 | Example | 57 | 96 | 0.200 | Co | 97 | 4.9 | 1.5 | 1.40 | 0.125 | 11.2 |
| G6 | Example | 120 | 0.1 | 0.200 | Co | 2 | 5.0 | 5.8 | 1.36 | 0.118 | 11.5 |
| D16 | Example | 120 | 1.8 | 0.200 | Co | 22 | 4.9 | 6.1 | 1.38 | 0.122 | 11.3 |
| G7 | Example | 120 | 5 | 0.200 | Co | 49 | 5.0 | 5.9 | 1.39 | 0.126 | 11.0 |
| G8 | Example | 120 | 8 | 0.200 | Co | 71 | 4.9 | 5.7 | 1.42 | 0.130 | 10.9 |
| G9 | Example | 170 | 0.05 | 0.200 | Co | 3 | 5.0 | 10.0 | 1.39 | 0.120 | 11.6 |
| D18 | Example | 170 | 1 | 0.200 | Co | 20 | 4.8 | 9.9 | 1.41 | 0.124 | 11.4 |
| G10 | Example | 170 | 3 | 0.200 | Co | 52 | 5.0 | 9.8 | 1.43 | 0.128 | 11.2 |
| G11 | Example | 170 | 5 | 0.200 | Co | 68 | 4.8 | 9.7 | 1.45 | 0.132 | 11.0 |
| G16 | Example | 180 | 0.01 | 0.200 | Co | 2 | 4.8 | 10.3 | 1.34 | 0.130 | 10.3 |
| D24 | Example | 180 | 0.8 | 0.200 | Co | 20 | 4.9 | 10.3 | 1.36 | 0.134 | 10.1 |
| G17 | Example | 180 | 2 | 0.200 | Co | 47 | 4.8 | 10.2 | 1.37 | 0.136 | 10.1 |
| G18 | Example | 180 | 3 | 0.200 | Co | 73 | 5.0 | 10.1 | 1.38 | 0.138 | 10.0 |

In any of examples shown in Table 5 to Table 7, the high magnetic permeability and the low magnetic loss were compatible with each other at 5 GHz. From the evaluation results in Experiment 4, it could be seen that when FW2/FW1 is set to 1 to 5, the high magnetic permeability and high performance index (high magnetic permeability and low magnetic loss) can be obtained at a high-frequency band, and the magnetic permeability and the performance index can be further improved by adjusting 12/I1 and the average particle size (D50).

(Experiment 5)

In Experiment 5, metal magnetic powders including an additive element M and composite magnetic bodies were manufactured under conditions shown in Table 8 to Table 10. Specifically, in Experiment 5, an additive material including the additive element M was put into a high-pressure reaction container in combination with a precursor (Co₂(CO)₈) of Co, and Co nanoparticles were synthesized under conditions shown in the respective tables. Magnesium chloride (MgCl₂·6H₂O) was used as the additive material in a case of adding Mg, iron chloride (FeCl₃) was used as the additive material in a case of adding Fe, and copper chloride (CuCl₂) was used as the additive material in a case of adding Cu.

In respective examples shown in Table 8, the metal magnetic powders were manufactured in conditions in which the reaction temperature is set to 57° C., the reaction time is set to three hours, and the pressure inside the reaction container is set to 0.05 MPa. That is, Table 8 shows evaluation results of samples in which the average particle size (D50) is set to 20±3 nm, and FW2/FW1 is set to 2.0±0.2 in order to confirm an effect due to the additive element M.

In respective examples shown in Table 9, the metal magnetic powders were manufactured by setting the reaction temperature to 57° C. and setting the reaction time to three hours and by changing the pressure inside the reaction container. That is, Table 9 shows evaluation results of samples to which the additive element M was added by changing FW2/FW1.

In respective examples shown in Table 10, the metal magnetic powders were manufactured by setting the pressure inside the reaction container to 0.05 MPa so that FW2/FW1 is within a range of 2.0±0.2, and by changing the reaction temperature and the reaction time. That is, Table 10 shows evaluation results of samples to which the additive element M was added by changing the average particle size of the metal magnetic powders.

Manufacturing conditions other than manufacturing conditions shown in Table 8 to Table 10 were set to be similar as in Experiment 1, and the magnetic characteristics of the respective samples related to Experiment 5 were evaluated. The content ratio (ppm) of the additive element M shown in the respective tables is a ratio of W_{M} to W_{T} (that is, (Fe+Mg+Cu)/(Co+Fe+Mg+Cu)), and was analyzed with ICP-AES. Note that, spot analysis, line analysis, and mapping analysis with TEM-EDS were performed on a cross-section of each of the composite magnetic bodies, and from the analysis, it could be confirmed that in examples to which the additive element M was added, the additive element M exists at the inside of the nanoparticles and/or on the surface of the nanoparticles.

TABLE 8

| | Example/ | Powder manufacturing conditions | | | |
|---|---|---|---|---|---|
| | Comparative | Reaction temperature | Reaction time | Pressure | |
| Sample No. | Example | (° C.) | (h) | (MPa) | Additive material |
| A4 | Example | 57 | 3 | 0.050 | — |
| H1 | Example | 57 | 3 | 0.050 | MgCl₂•6H₂O |
| H2 | Example | 57 | 3 | 0.050 | MgCl₂•6H₂O |
| H3 | Example | 57 | 3 | 0.050 | MgCl₂•6H₂O |
| H4 | Example | 57 | 3 | 0.050 | FeCl₃ |
| H5 | Example | 57 | 3 | 0.050 | FeCl₃ |
| H6 | Example | 57 | 3 | 0.050 | FeCl₃ |
| H7 | Example | 57 | 3 | 0.050 | CuCl₂ |
| H8 | Example | 57 | 3 | 0.050 | CuCl₂ |
| H9 | Example | 57 | 3 | 0.050 | CuCl₂ |
| H10 | Example | 57 | 3 | 0.050 | MgCl₂•6H₂O, FeCl₃ |
| H11 | Example | 57 | 3 | 0.050 | MgCl₂•6H₂O, FeCl₃ |
| H12 | Example | 57 | 3 | 0.050 | MgCl₂•6H₂O, FeCl₃ |
| H13 | Example | 57 | 3 | 0.050 | MgCl₂•6H₂O, CuCl₂ |
| H14 | Example | 57 | 3 | 0.050 | MgCl₂•6H₂O, CuCl₂ |
| H15 | Example | 57 | 3 | 0.050 | MgCl₂•6H₂O, CuCl₂ |
| H16 | Example | 57 | 3 | 0.050 | FeCl₃ , CuCl₂ |
| H17 | Example | 57 | 3 | 0.050 | FeCl₃ , CuCl₂ |
| H18 | Example | 57 | 3 | 0.050 | FeCl₃ , CuCl₂ |
| H19 | Example | 57 | 3 | 0.050 | MgCl₂•6H₂O, FeCl₃, CuCl₂ |
| H20 | Example | 57 | 3 | 0.050 | MgCl₂•6H₂O, FeCl₃, CuCl₂ |
| H21 | Example | 57 | 3 | 0.050 | MgCl₂•6H₂O, FeCl₃, CuCl₂ |

| | Analysis results of metal magnetic powder | | | | | | | |
|---|---|---|---|---|---|---|---|---|
| | | | Additive element M | | | Magnetic characteristics at 5 GHz | | |
| | | | | Content | FW2/ | Magnetic | Magnetic | |
| | Main | D50 | | ratio | FW1 | permeability | loss | Performance |
| Sample No. | component | (nm) | Kind | (ppm) | (—) | μ′ | tanδ | index |
| A4 | Co | 21 | — | — | 2.1 | 1.26 | 0.086 | 14.7 |
| H1 | Co | 18 | Mg | 10 | 1.9 | 1.26 | 0.075 | 16.8 |
| H2 | Co | 19 | Mg | 120 | 1.8 | 1.25 | 0.075 | 16.7 |
| H3 | Co | 17 | Mg | 480 | 1.8 | 1.23 | 0.074 | 16.6 |
| H4 | Co | 21 | Fe | 20 | 2.1 | 1.25 | 0.074 | 16.9 |
| H5 | Co | 21 | Fe | 90 | 2.2 | 1.24 | 0.075 | 16.5 |
| H6 | Co | 21 | Fe | 520 | 2.2 | 1.23 | 0.074 | 16.6 |
| H7 | Co | 19 | Cu | 10 | 2.0 | 1.25 | 0.076 | 16.4 |
| H8 | Co | 21 | Cu | 90 | 2.0 | 1.25 | 0.075 | 16.7 |
| H9 | Co | 22 | Cu | 500 | 2.2 | 1.24 | 0.075 | 16.5 |
| H10 | Co | 17 | Mg, Fe | 30 | 1.9 | 1.27 | 0.075 | 16.9 |
| H11 | Co | 17 | Mg, Fe | 140 | 1.8 | 1.26 | 0.074 | 17.0 |
| H12 | Co | 19 | Mg, Fe | 450 | 2.1 | 1.24 | 0.073 | 17.0 |
| H13 | Co | 20 | Mg, Cu | 20 | 2.1 | 1.26 | 0.076 | 16.6 |
| H14 | Co | 17 | Mg, Cu | 140 | 2.0 | 1.26 | 0.075 | 16.8 |
| H15 | Co | 17 | Mg, Cu | 550 | 2.2 | 1.24 | 0.074 | 16.8 |
| H16 | Co | 20 | Fe, Cu | 10 | 1.8 | 1.26 | 0.074 | 17.0 |
| H17 | Co | 23 | Fe, Cu | 90 | 2.0 | 1.25 | 0.074 | 16.9 |
| H18 | Co | 21 | Fe, Cu | 530 | 1.8 | 1.24 | 0.072 | 17.2 |
| H19 | Co | 23 | Mg, Fe, Cu | 30 | 2.0 | 1.25 | 0.074 | 16.9 |
| H20 | Co | 18 | Mg, Fe, Cu | 150 | 1.8 | 1.24 | 0.074 | 16.8 |
| H21 | Co | 19 | Mg, Fe, Cu | 540 | 1.8 | 1.24 | 0.073 | 17.0 |

TABLE 9

| | Example/ | Powder manufacturing conditions | | | |
|---|---|---|---|---|---|
| | Comparative | Reaction temperature | Reaction time | Pressure | |
| Sample No. | Example | (° C.) | (h) | (MPa) | Additive material |
| A2 | Example | 57 | 3 | 0.010 | — |
| J1 | Example | 57 | 3 | 0.010 | MgCl₂•6H₂O |
| J2 | Example | 57 | 3 | 0.010 | FeCl₃ |
| J3 | Example | 57 | 3 | 0.010 | CuCl₂ |
| J4 | Example | 57 | 3 | 0.010 | MgCl₂•6H₂O, FeCl₃, CuCl₂ |
| J5 | Example | 57 | 3 | 0.010 | MgCl₂•6H₂O, FeCl₃, CuCl₂ |
| J6 | Example | 57 | 3 | 0.010 | MgCl₂•6H₂O, FeCl₃, CuCl₂ |
| A4 | Example | 57 | 3 | 0.050 | — |
| H2 | Example | 57 | 3 | 0.050 | MgCl₂•6H₂O |
| H5 | Example | 57 | 3 | 0.050 | FeCl₃ |
| H8 | Example | 57 | 3 | 0.050 | CuCl₂ |
| H19 | Example | 57 | 3 | 0.050 | MgCl₂•6H₂O, FeCl₃, CuCl₂ |
| H20 | Example | 57 | 3 | 0.050 | MgCl₂•6H₂O, FeCl₃, CuCl₂ |
| H21 | Example | 57 | 3 | 0.050 | MgCl₂•6H₂O, FeCl₃, CuCl₂ |
| A7 | Example | 57 | 3 | 0.200 | — |
| J7 | Example | 57 | 3 | 0.200 | MgCl₂•6H₂O |
| J8 | Example | 57 | 3 | 0.200 | FeCl₃ |
| J9 | Example | 57 | 3 | 0.200 | CuCl₂ |
| J10 | Example | 57 | 3 | 0.200 | MgCl₂•6H₂O, FeCl₃, CuCl₂ |
| J11 | Example | 57 | 3 | 0.200 | MgCl₂•6H₂O, FeCl₃, CuCl₂ |
| J12 | Example | 57 | 3 | 0.200 | MgCl₂•6H₂O, FeCl₃, CuCl₂ |

| | Analysis results of metal magnetic powder | | | | | | | |
|---|---|---|---|---|---|---|---|---|
| | | | Additive element M | | | Magnetic characteristics at 5 GHz | | |
| | | | | Content | FW2/ | Magnetic | Magnetic | |
| | Main | D50 | | ratio | FW1 | permeability | boss | Performance |
| Sample No. | component | (nm) | Kind | (ppm) | (—) | μ′ | tanδ | index |
| A2 | Co | 19 | — | — | 1.1 | 1.24 | 0.071 | 17.5 |
| J1 | Co | 20 | Mg | 80 | 1.1 | 1.24 | 0.066 | 18.8 |
| J2 | Co | 19 | Fe | 90 | 1.2 | 1.26 | 0.066 | 19.1 |
| J3 | Co | 19 | Cu | 110 | 1.1 | 1.25 | 0.065 | 19.2 |
| J4 | Co | 18 | Mg, Fe, Cu | 20 | 1.1 | 1.26 | 0.070 | 18.0 |
| J5 | Co | 20 | Mg, Fe, Cu | 130 | 1.2 | 1.25 | 0.066 | 18.9 |
| J6 | Co | 18 | Mg, Fe, Cu | 470 | 1.3 | 1.24 | 0.066 | 18.8 |
| A4 | Co | 21 | — | — | 2.1 | 1.26 | 0.086 | 14.7 |
| H2 | Co | 19 | Mg | 120 | 1.8 | 1.25 | 0.075 | 16.7 |
| H5 | Co | 21 | Fe | 90 | 2.2 | 1.24 | 0.075 | 16.5 |
| H8 | Co | 21 | Cu | 90 | 2.0 | 1.25 | 0.075 | 16.7 |
| H19 | Co | 23 | Mg, Fe, Cu | 30 | 2.0 | 1.25 | 0.074 | 16.9 |
| H20 | Co | 18 | Mg, Fe, Cu | 150 | 1.8 | 1.24 | 0.074 | 16.8 |
| H21 | Co | 19 | Mg, Fe, Cu | 540 | 1.8 | 1.24 | 0.073 | 17.0 |
| A7 | Co | 19 | — | — | 4.9 | 1.34 | 0.113 | 11.9 |
| J7 | Co | 19 | Mg | 110 | 4.9 | 1.36 | 0.107 | 12.7 |
| J8 | Co | 19 | Fe | 120 | 5.0 | 1.34 | 0.109 | 12.3 |
| J9 | Co | 21 | Cu | 80 | 4.7 | 1.36 | 0.110 | 12.4 |
| J10 | Co | 20 | Mg, Fe, Cu | 20 | 4.8 | 1.35 | 0.110 | 12.3 |
| J11 | Co | 18 | Mg, Fe, Cu | 90 | 5.0 | 1.35 | 0.109 | 12.4 |
| J12 | Co | 19 | Mg, Fe, Cu | 480 | 4.9 | 1.34 | 0.100 | 13.4 |

TABLE 10

| | Example/ | Powder manufacturing conditions | | | |
|---|---|---|---|---|---|
| | Comparative | Reaction temperature | Reaction time | Pressure | |
| Sample No. | Example | (° C.) | (h) | (MPa) | Additive material |
| B13 | Example | 57 | 1 | 0.050 | — |
| A4 | Example | 57 | 3 | 0.050 | — |
| B14 | Example | 57 | 12 | 0.050 | — |
| B15 | Example | 57 | 96 | 0.050 | — |
| K1 | Example | 57 | 1 | 0.050 | MgCl₂•6H₂O |
| H2 | Example | 57 | 3 | 0.050 | MgCl₂•6H₂O |
| K2 | Example | 57 | 12 | 0.050 | MgCl₂•6H₂O |
| K3 | Example | 57 | 96 | 0.050 | MgCl₂•6H₂O |
| K4 | Example | 57 | 1 | 0.050 | FeCl₃ |
| H5 | Example | 57 | 3 | 0.050 | FeCl₃ |
| K5 | Example | 57 | 12 | 0.050 | FeCl₃ |
| K6 | Example | 57 | 96 | 0.050 | FeCl₃ |
| K7 | Example | 57 | 1 | 0.050 | CuCl₂ |
| H8 | Example | 57 | 3 | 0.050 | CuCl₂ |
| K8 | Example | 57 | 12 | 0.050 | CuCl₂ |
| K9 | Example | 57 | 96 | 0.050 | CuCl₂ |
| K10 | Example | 57 | 1 | 0.050 | MgCl₂•6H₂O, FeCl₃, CuCl₂ |
| H19 | Example | 57 | 3 | 0.050 | MgCl₂•6H₂O, FeCl₃, CuCl₂ |
| K11 | Example | 57 | 12 | 0.050 | MgCl₂•6H₂O, FeCl₃, CuCl₂ |
| K12 | Example | 57 | 96 | 0.050 | MgCl₂•6H₂O, FeCl₃, CuCl₂ |
| K13 | Example | 57 | 1 | 0.050 | MgCl₂•6H₂O, FeCl₃, CuCl₂ |
| H20 | Example | 57 | 3 | 0.050 | MgCl₂•6H₂O, FeCl₃, CuCl₂ |
| K14 | Example | 57 | 12 | 0.050 | MgCl₂•6H₂O, FeCl₃, CuCl₂ |
| K15 | Example | 57 | 96 | 0.050 | MgCl₂•6H₂O, FeCl₃, CuCl₂ |
| K16 | Example | 57 | 1 | 0.050 | MgCl₂•6H₂O, FeCl₃, CuCl₂ |
| H21 | Example | 57 | 3 | 0.050 | MgCl₂•6H₂O, FeCl₃, CuCl₂ |
| K17 | Example | 57 | 12 | 0.050 | MgCl₂•6H₂O, FeCl₃, CuCl₂ |
| K18 | Example | 57 | 96 | 0.050 | MgCl₂•6H₂O, FeCl₃, CuCl₂ |

| | Analysis results of metal magnetic powder | | | | | | | |
|---|---|---|---|---|---|---|---|---|
| | | | Additive element M | | | Magnetic characteristics at 5 GHz | | |
| | | | | Content | FW2/ | Magnetic | Magnetic | |
| | Main | D50 | | ratio | FW1 | permeability | loss | Performance |
| Sample No. | component | (nm) | Kind | (ppm) | (—) | μ′ | tanδ | index |
| B13 | Co | 3 | — | — | 2.0 | 1.24 | 0.085 | 14.6 |
| A4 | Co | 21 | — | — | 2.1 | 1.26 | 0.086 | 14.7 |
| B14 | Co | 49 | — | — | 2.2 | 1.29 | 0.087 | 14.8 |
| B15 | Co | 98 | — | — | 2.1 | 1.33 | 0.089 | 14.9 |
| K1 | Co | 2 | Mg | 110 | 1.8 | 1.24 | 0.075 | 16.5 |
| H2 | Co | 19 | Mg | 120 | 1.8 | 1.25 | 0.075 | 16.7 |
| K2 | Co | 51 | Mg | 90 | 1.8 | 1.30 | 0.078 | 16.7 |
| K3 | Co | 98 | Mg | 100 | 1.8 | 1.32 | 0.079 | 16.7 |
| K4 | Co | 3 | Fe | 80 | 1.8 | 1.23 | 0.075 | 16.4 |
| H5 | Co | 21 | Fe | 90 | 2.2 | 1.24 | 0.075 | 16.5 |
| K5 | Co | 48 | Fe | 140 | 2.1 | 1.30 | 0.078 | 16.7 |
| K6 | Co | 100 | Fe | 110 | 2.0 | 1.33 | 0.080 | 16.6 |
| K7 | Co | 2 | Cu | 90 | 2.2 | 1.23 | 0.074 | 16.6 |
| H8 | Co | 21 | Cu | 90 | 2.0 | 1.25 | 0.075 | 16.7 |
| K8 | Co | 50 | Cu | 120 | 1.8 | 1.28 | 0.076 | 16.8 |
| K9 | Co | 99 | Cu | 110 | 1.9 | 1.32 | 0.080 | 16.5 |
| K10 | Co | 2 | Mg, Fe, Cu | 20 | 1.9 | 1.23 | 0.073 | 16.8 |
| H19 | Co | 23 | Mg, Fe, Cu | 30 | 2.0 | 1.25 | 0.074 | 16.9 |
| K11 | Co | 51 | Mg, Fe, Cu | 20 | 1.8 | 1.30 | 0.077 | 16.9 |
| K12 | Co | 97 | Mg, Fe, Cu | 10 | 2.1 | 1.33 | 0.079 | 16.8 |
| K13 | Co | 3 | Mg, Fe, Cu | 120 | 2.0 | 1.24 | 0.074 | 16.8 |
| H20 | Co | 18 | Mg, Fe, Cu | 150 | 1.8 | 1.24 | 0.074 | 16.8 |
| K14 | Co | 49 | Mg, Fe, Cu | 110 | 1.8 | 1.29 | 0.078 | 16.5 |
| K15 | Co | 99 | Mg, Fe, Cu | 110 | 2.1 | 1.32 | 0.081 | 16.3 |
| K16 | Co | 2 | Mg, Fe, Cu | 470 | 2.2 | 1.23 | 0.073 | 16.8 |
| H21 | Co | 19 | Mg, Fe, Cu | 540 | 1.8 | 1.24 | 0.073 | 17.0 |
| K17 | Co | 50 | Mg, Fe, Cu | 520 | 2.1 | 1.28 | 0.077 | 16.6 |
| K18 | Co | 98 | Mg, Fe, Cu | 490 | 1.9 | 1.33 | 0.080 | 16.6 |

As shown in Table 8 to Table 10, even in examples including the additive element M, the high magnetic permeability and the high performance index were compatible with each other at 5 GHz. Particularly, in examples including the additive element M, it could be confirmed that the magnetic loss can be further reduced and the performance index is further improved in comparison to examples which do not include the additive element.

Note that, it could be seen that the additive element M that is added to the metal magnetic powder may be only one kind or a plurality of kinds among Fe, Mg, and Cu. In addition, it could be seen that the content ratio (W_{M}/W_{T}) of the additive element M is preferably 10 ppm to 550 ppm.

(Experiment 6)

In Experiment 6, metal magnetic powders and composite magnetic bodies were manufactured under conditions shown in Table 11 and Table 12. Specifically, Table 11 shows evaluation results of examples different in the ratio (FW2/FW1) of the full widths at half maximum and the ratio (I2/I1) of the intensity intensities, and in the respective examples shown in Table 11, D50 was controlled within a range of 20±3 nm, and the content ratio (Wm/W T) of the additive element M was controlled within a range of 500±30 ppm. In addition, Table 12 shows evaluation results of examples different in D50, FW2/FW1, and I2/I1, and in the respective examples shown in Table 12, W_{M}/W_{T} was controlled within a range of 500±30 ppm. Manufacturing conditions other than the conditions shown in Table 11 and Table 12 were set to be similar as in Experiment 5, and the magnetic characteristics of the respective samples related to Experiment 6 were evaluated.

TABLE 11

| | Example/ | Powder manufacturing conditions | | | |
|---|---|---|---|---|---|
| | Comparative | Reaction temperature | Reaction time | | |
| Sample No. | Example | (° C.) | (h) | Pressure (MPa) | Additive material |
| L1 | Example | 55 | 4.0 | 0.010 | MgCl₂•6H₂O |
| L2 | Example | 120 | 1.8 | 0.010 | MgCl₂•6H₂O |
| L3 | Example | 55 | 4.0 | 0.100 | MgCl₂•6H₂O |
| L4 | Example | 120 | 1.8 | 0.100 | MgCl₂•6H₂O |
| L5 | Example | 170 | 1.0 | 0.100 | MgCl₂•6H₂O |
| L6 | Example | 55 | 4.0 | 0.200 | MgCl₂•6H₂O |
| L7 | Example | 120 | 1.8 | 0.200 | MgCl₂•6H₂O |
| L8 | Example | 55 | 4.0 | 0.010 | FeCl₃ |
| L9 | Example | 120 | 1.0 | 0.010 | FeCl₃ |
| L10 | Example | 55 | 4.0 | 0.100 | FeCl₃ |
| L11 | Example | 120 | 1.8 | 0.100 | FeCl₃ |
| L12 | Example | 170 | 1.0 | 0.100 | FeCl₃ |
| L13 | Example | 55 | 4.0 | 0.200 | FeCl₃ |
| L14 | Example | 120 | 1.8 | 0.200 | FeCl₃ |
| L15 | Example | 55 | 4.0 | 0.010 | CuCl₂ |
| L16 | Example | 120 | 1.8 | 0.010 | CuCl₂ |
| L17 | Example | 55 | 4.0 | 0.100 | CuCl₂ |
| L18 | Example | 120 | 1.8 | 0.100 | CuCl₂ |
| L19 | Example | 170 | 1.0 | 0.100 | CuCl₂ |
| L20 | Example | 55 | 4.0 | 0.200 | CuCl₂ |
| L21 | Example | 120 | 1.8 | 0.200 | CuCl₂ |
| L22 | Example | 55 | 4.0 | 0.010 | MgCl₂•6H₂O, FeCl₃, CuCl₂ |
| L23 | Example | 120 | 1.8 | 0.010 | MgCl₂•6H₂O, FeCl₃, CuCl₂ |
| L24 | Example | 170 | 1.0 | 0.010 | MgCl₂•6H₂O, FeCl₃, CuCl₂ |
| L25 | Example | 55 | 4.0 | 0.100 | MgCl₂•6H₂O, FeCl₃, CuCl₂ |
| L26 | Example | 120 | 1.8 | 0.100 | MgCl₂•6H₂O, FeCl₃, CuCl₂ |
| L27 | Example | 170 | 1.0 | 0.100 | MgCl₂•6H₂O, FeCl₃, CuCl₂ |
| L28 | Example | 55 | 4.0 | 0.200 | MgCl₂•6H₂O, FeCl₃, CuCl₂ |
| L29 | Example | 120 | 1.8 | 0.200 | MgCl₂•6H₂O, FeCl₃, CuCl₂ |
| L30 | Example | 170 | 1.0 | 0.200 | MgCl₂•6H₂O, FeCl₃, CuCl₂ |

| | Analysis results of metal magnetic powder | | | | | | | | |
|---|---|---|---|---|---|---|---|---|---|
| | | | Additive element M | | | | Magnetic characteristics at 5 GHz | | |
| | | | | Content | FW2/ | | Magnetic | | |
| Sample | Main | D50 | | ratio | FW1 | | permeability | Magnetic loss | Performance |
| No. | component | (nm) | Kind | (ppm) | (—) | I2/I1 | μ′ | tanδ | index |
| L1 | Co | 22 | Mg | 480 | 1.1 | 1.3 | 1.22 | 0.058 | 21.0 |
| L2 | Co | 20 | Mg | 500 | 1.1 | 4.7 | 1.25 | 0.063 | 19.8 |
| L3 | Co | 23 | Mg | 520 | 2.9 | 1.2 | 1.26 | 0.080 | 15.8 |
| L4 | Co | 19 | Mg | 510 | 3.0 | 5.2 | 1.34 | 0.092 | 14.6 |
| L5 | Co | 23 | Mg | 520 | 3.1 | 9.9 | 1.38 | 0.098 | 14.1 |
| L6 | Co | 19 | Mg | 530 | 4.8 | 1.1 | 1.32 | 0.099 | 13.3 |
| L7 | Co | 18 | Mg | 480 | 4.9 | 4.7 | 1.38 | 0.112 | 12.3 |
| L8 | Co | 20 | Fe | 480 | 1.2 | 1.2 | 1.23 | 0.059 | 20.8 |
| L9 | Co | 21 | Fe | 480 | 1.1 | 4.8 | 1.25 | 0.062 | 20.2 |
| L10 | Co | 19 | Fe | 480 | 3.1 | 1.1 | 1.25 | 0.081 | 15.4 |
| L11 | Co | 20 | Fe | 470 | 3.1 | 5.0 | 1.33 | 0.092 | 14.5 |
| L12 | Co | 17 | Fe | 470 | 2.8 | 9.6 | 1.37 | 0.098 | 14.0 |
| L13 | Co | 23 | Fe | 520 | 4.8 | 1.4 | 1.33 | 0.101 | 13.2 |
| L14 | Co | 17 | Fe | 530 | 5.0 | 5.4 | 1.39 | 0.110 | 12.6 |
| L15 | Co | 19 | Cu | 490 | 1.2 | 1.1 | 1.22 | 0.057 | 21.4 |
| L16 | Co | 21 | Cu | 530 | 1.1 | 4.9 | 1.24 | 0.063 | 19.7 |
| L17 | Co | 17 | Cu | 530 | 3.2 | 1.3 | 1.27 | 0.081 | 15.7 |
| L18 | Co | 23 | Cu | 480 | 3.0 | 5.2 | 1.35 | 0.091 | 14.8 |
| L19 | Co | 18 | Cu | 510 | 3.2 | 10.0 | 1.38 | 0.097 | 14.2 |
| L20 | Co | 22 | Cu | 520 | 4.7 | 1.1 | 1.33 | 0.098 | 13.6 |
| L21 | Co | 17 | Cu | 500 | 4.9 | 4.7 | 1.38 | 0.111 | 12.4 |
| L22 | Co | 22 | Mg, Fe, Cu | 520 | 1.2 | 1.1 | 1.21 | 0.057 | 21.2 |
| L23 | Co | 22 | Mg, Fe, Cu | 520 | 1.1 | 4.6 | 1.25 | 0.062 | 20.2 |
| L24 | Co | 20 | Mg, Fe, Cu | 530 | 1.2 | 9.7 | 1.30 | 0.069 | 18.8 |
| L25 | Co | 21 | Mg, Fe, Cu | 520 | 3.0 | 1.3 | 1.25 | 0.080 | 15.6 |
| L26 | Co | 20 | Mg, Fe, Cu | 510 | 3.0 | 4.6 | 1.33 | 0.091 | 14.6 |
| L27 | Co | 18 | Mg, Fe, Cu | 520 | 2.5 | 9.8 | 1.39 | 0.099 | 14.0 |
| L28 | Co | 22 | Mg, Fe, Cu | 480 | 4.7 | 1.2 | 1.31 | 0.098 | 13.4 |
| L29 | Co | 17 | Mg, Fe, Cu | 470 | 5.0 | 5.1 | 1.37 | 0.113 | 12.1 |
| L30 | Co | 18 | Mg, Fe, Cu | 520 | 4.9 | 9.7 | 1.42 | 0.120 | 11.8 |

TABLE 12

| | | | | | | Analysis results of metal magnetic powder | | | | | | | | |
|---|---|---|---|---|---|---|---|---|---|---|---|---|---|---|
| | | Powder manufacturing conditions | | | | | | Additive element M | | | | Magnetic characteristics at 5 GHz | | |
| | Example/ | Reaction | | | | | | | Content | | | Magnetic | Magnetic | |
| | Comparative | temperature | Reaction time | Pressure | | Main | D50 | | ratio | FW2/FW1 | I2/I1 | permeability | loss | Performance |
| Sample No. | Example | (° C.) | (h) | (MPa) | Additive material | component | (nm) | Kind | (ppm) | (—) | (—) | μ′ | tanδ | index |
| M1 | Example | 55 | 1.5 | 0.010 | MgCl₂•6H₂O, FeCl₃, CuCl₂ | Co | 3 | Mg, Fe, Cu | 500 | 1.1 | 1.1 | 1.20 | 0.055 | 21.8 |
| M2 | Example | 55 | 1.5 | 0.100 | MgCl₂•6H₂O, FeCl₃, CuCl₂ | Co | 2 | Mg, Fe, Cu | 520 | 2.8 | 1.1 | 1.23 | 0.077 | 16.0 |
| M3 | Example | 55 | 1.5 | 0.200 | MgCl₂•6H₂O, FeCl₃, CuCl₂ | Co | 4 | Mg, Fe, Cu | 510 | 4.9 | 1.3 | 1.28 | 0.095 | 13.5 |
| L22 | Example | 55 | 4.0 | 0.010 | MgCl₂•6H₂O, FeCl₃, CuCl₂ | Co | 22 | Mg, Fe, Cu | 520 | 1.2 | 1.1 | 1.21 | 0.057 | 21.2 |
| L25 | Example | 55 | 4.0 | 0.100 | MgCl₂•6H₂O, FeCl₃, CuCl₂ | Co | 21 | Mg, Fe, Cu | 520 | 3.0 | 1.3 | 1.25 | 0.080 | 15.6 |
| L28 | Example | 55 | 4.0 | 0.200 | MgCl₂•6H₂O, FeCl₃, CuCl₂ | Co | 22 | Mg, Fe, Cu | 480 | 4.7 | 1.2 | 1.31 | 0.098 | 13.4 |
| M4 | Example | 55 | 15.0 | 0.010 | MgCl₂•6H₂O, FeCl₃, CuCl₂ | Co | 48 | Mg, Fe, Cu | 470 | 1.2 | 1.2 | 1.24 | 0.060 | 20.7 |
| M5 | Example | 55 | 15.0 | 0.100 | MgCl₂•6H₂O, FeCl₃, CuCl₂ | Co | 51 | Mg, Fe, Cu | 480 | 2.9 | 1.2 | 1.28 | 0.083 | 15.4 |
| M6 | Example | 55 | 15.0 | 0.200 | MgCl₂•6H₂O, FeCl₃, CuCl₂ | Co | 53 | Mg, Fe, Cu | 470 | 4.9 | 1.3 | 1.34 | 0.100 | 13.4 |
| M7 | Example | 55 | 105.0 | 0.010 | MgCl₂•6H₂O, FeCl₃, CuCl₂ | Co | 96 | Mg, Fe, Cu | 480 | 1.1 | 1.2 | 1.27 | 0.064 | 19.8 |
| M8 | Example | 55 | 105.0 | 0.100 | MgCl₂•6H₂O, FeCl₃, CuCl₂ | Co | 98 | Mg, Fe, Cu | 510 | 3.1 | 1.1 | 1.31 | 0.087 | 15.1 |
| M9 | Example | 55 | 105.0 | 0.200 | MgCl₂•6H₂O, FeCl₃, CuCl₂ | Co | 95 | Mg, Fe, Cu | 520 | 4.8 | 1.2 | 1.37 | 0.105 | 13.0 |
| M10 | Example | 120 | 0.1 | 0.010 | MgCl₂•6H₂O, FeCl₃, CuCl₂ | Co | 4 | Mg, Fe, Cu | 510 | 1.1 | 4.8 | 1.23 | 0.059 | 20.8 |
| M11 | Example | 120 | 0.1 | 0.100 | MgCl₂•6H₂O, FeCl₃, CuCl₂ | Co | 3 | Mg, Fe, Cu | 510 | 3.1 | 4.9 | 1.29 | 0.082 | 15.7 |
| M12 | Example | 120 | 0.1 | 0.200 | MgCl₂•6H₂O, FeCl₃, CuCl₂ | Co | 3 | Mg, Fe, Cu | 530 | 4.9 | 5.2 | 1.33 | 0.106 | 12.5 |
| L23 | Example | 120 | 1.8 | 0.010 | MgCl₂•6H₂O, FeCl₃, CuCl₂ | Co | 22 | Mg, Fe, Cu | 520 | 1.1 | 4.6 | 1.25 | 0.062 | 20.2 |
| L26 | Example | 120 | 1.8 | 0.100 | MgCl₂•6H₂O, FeCl₃, CuCl₂ | Co | 20 | Mg, Fe, Cu | 510 | 3.0 | 4.6 | 1.33 | 0.091 | 14.6 |
| L29 | Example | 120 | 1.8 | 0.200 | MgCl₂•6H₂O, FeCl₃, CuCl₂ | Co | 17 | Mg, Fe, Cu | 470 | 5.0 | 5.1 | 1.37 | 0.113 | 12.1 |
| M13 | Example | 120 | 5.0 | 0.010 | MgCl₂•6H₂O, FeCl₃, CuCl₂ | Co | 45 | Mg, Fe, Cu | 490 | 1.2 | 4.8 | 1.28 | 0.066 | 19.4 |
| M14 | Example | 120 | 5.0 | 0.100 | MgCl₂•6H₂O, FeCl₃, CuCl₂ | Co | 53 | Mg, Fe, Cu | 520 | 2.9 | 5.1 | 1.35 | 0.095 | 14.2 |
| M15 | Example | 120 | 5.0 | 0.200 | MgCl₂•6H₂O, FeCl₃, CuCl₂ | Co | 50 | Mg, Fe, Cu | 530 | 4.7 | 4.9 | 1.40 | 0.116 | 12.1 |
| M16 | Example | 120 | 8.0 | 0.010 | MgCl₂•6H₂O, FeCl₃, CuCl₂ | Co | 66 | Mg, Fe, Cu | 500 | 1.3 | 4.8 | 1.31 | 0.069 | 19.0 |
| M17 | Example | 120 | 8.0 | 0.100 | MgCl₂•6H₂O, FeCl₃, CuCl₂ | Co | 68 | Mg, Fe, Cu | 500 | 3.4 | 4.7 | 1.37 | 0.098 | 14.0 |
| M18 | Example | 120 | 8.0 | 0.200 | MgCl₂•6H₂O, FeCl₃, CuCl₂ | Co | 69 | Mg, Fe, Cu | 530 | 5.0 | 5.3 | 1.42 | 0.119 | 11.9 |
| M19 | Example | 170 | 0.05 | 0.010 | MgCl₂•6H₂O, FeCl₃, CuCl₂ | Co | 3 | Mg, Fe, Cu | 470 | 1.4 | 9.9 | 1.28 | 0.066 | 19.4 |
| M20 | Example | 170 | 0.05 | 0.100 | MgCl₂•6H₂O, FeCl₃, CuCl₂ | Co | 2 | Mg, Fe, Cu | 490 | 2.6 | 9.8 | 1.35 | 0.096 | 14.1 |
| M21 | Example | 170 | 0.05 | 0.200 | MgCl₂•6H₂O, FeCl₃, CuCl₂ | Co | 4 | Mg, Fe, Cu | 510 | 4.6 | 9.5 | 1.38 | 0.115 | 12.0 |
| L24 | Example | 170 | 1.0 | 0.010 | MgCl₂•6H₂O, FeCl₃, CuCl₂ | Co | 20 | Mg, Fe, Cu | 530 | 1.2 | 9.7 | 1.30 | 0.069 | 18.8 |
| L27 | Example | 170 | 1.0 | 0.100 | MgCl₂•6H₂O, FeCl₃, CuCl₂ | Co | 18 | Mg, Fe, Cu | 520 | 2.9 | 9.8 | 1.39 | 0.099 | 14.0 |
| L30 | Example | 170 | 1.0 | 0.200 | MgCl₂•6H₂O, FeCl₃, CuCl₂ | Co | 18 | Mg, Fe, Cu | 520 | 4.9 | 9.7 | 1.42 | 0.120 | 11.8 |
| M22 | Example | 170 | 3.0 | 0.010 | MgCl₂•6H₂O, FeCl₃, CuCl₂ | Co | 47 | Mg, Fe, Cu | 500 | 1.1 | 9.8 | 1.33 | 0.072 | 18.5 |
| M23 | Example | 170 | 3.0 | 0.100 | MgCl₂•6H₂O, FeCl₃, CuCl₂ | Co | 46 | Mg, Fe, Cu | 520 | 3.3 | 9.7 | 1.42 | 0.103 | 13.8 |
| M24 | Example | 170 | 3.0 | 0.200 | MgCl₂•6H₂O, FeCl₃, CuCl₂ | Co | 50 | Mg, Fe, Cu | 480 | 4.9 | 9.9 | 1.45 | 0.125 | 11.6 |
| M25 | Example | 170 | 5.0 | 0.010 | MgCl₂•6H₂O, FeCl₃, CuCl₂ | Co | 66 | Mg, Fe, Cu | 480 | 1.2 | 9.8 | 1.35 | 0.077 | 17.5 |
| M26 | Example | 170 | 5.0 | 0.100 | MgCl₂•6H₂O, FeCl₃, CuCl₂ | Co | 71 | Mg, Fe, Cu | 500 | 2.8 | 10.0 | 1.44 | 0.109 | 13.2 |
| M27 | Example | 170 | 5.0 | 0.200 | MgCl₂•6H₂O, FeCl₃, CuCl₂ | Co | 73 | Mg, Fe, Cu | 480 | 5.0 | 9.9 | 1.47 | 0.130 | 11.3 |

As shown in Table 11 and Table 12, in all examples in Experiment 6, the high magnetic permeability and the high performance index were compatible with each other at 5 GHz.

(Experiment 7)

In Experiment 7, metal magnetic powders were manufactured under the same conditions as in Sample A2 (example) in Experiment 1, and composite magnetic bodies related to Sample A2a to Sample A2e were manufactured by changing a blending ratio of the metal magnetic powders. The blending ratio of the metal magnetic powders in the respective samples was controlled so that content ratios of the nanoparticles in the composite magnetic bodies become values shown in Table 13. Note that, manufacturing conditions other than the blending ratio of the metal magnetic powders were set to be similar as in Sample A2.

In addition, in Experiment 7, metal magnetic powders were manufactured under the same conditions as in Sample A7 (example) in Experiment 1, and Samples B5, B6, B25, and B26 (examples) in Experiment 2, and composite magnetic bodies related to Sample A7a, Sample B5a, Sample B6a, Sample B25a, and Sample B26a were manufactured by changing the blending ratio of the metal magnetic powders. The blending ratio of the metal magnetic powders in the respective samples was controlled so that the content ratio of the nanoparticles in the composite magnetic bodies becomes 40 vol %. Note that, manufacturing conditions other than the blending ratio of the metal magnetic powders were set to be similar as in Experiment 1 or Experiment 2.

In addition, in Experiment 7, metal magnetic powders were manufactured under the same conditions as in Sample G11 (example) in Experiment 4, and composite magnetic bodes related to Samples G11a to G11e were manufactured by changing the blending ratio of the metal magnetic powders. The blending ratio of the metal magnetic powders in the respective samples was controlled so that the content ratio of the nanoparticles in the composite magnetic bodies becomes values shown in Table 13. Note that, manufacturing conditions other than the blending ratio of the metal magnetic powders were set to be similar as in Experiment 4.

In addition, in Experiment 7, composite magnetic bodies related to Sample A1a to Sample A1e as comparative examples were also manufactured. In respective Sample A1a to Sample A1e, metal magnetic powders were manufactured by using a non-pressurization type reaction container under the same conditions as in Sample A1 that is a comparative example in Experiment 1. Then, composite magnetic bodies were obtained by adjusting the blending ratio of the metal magnetic powders so that the content ratio of the nanoparticles in the composite magnetic bodies becomes values shown in Table 13. Note that, manufacturing conditions other than the blending ratio of the metal magnetic powders were set to be similar as in Comparative Example A1.

In addition, in Experiment 7, a cross-section of each of the manufactured composite magnetic bodies was observed with a TEM to measure an area ratio of the metal magnetic powder (nanoparticles) included in the composite magnetic body. As a result, in respective examples and comparative examples, it could be confirmed that the area ratio of the nanoparticles approximately matches an intended value (vol %) shown in Table 13.

Evaluation results in Experiment 7 are shown in Table 13.

TABLE 13

| | | Powder | | | Analysis results of metal | | |
|---|---|---|---|---|---|---|---|
| | | manufacturing conditions | | | magnetic powder | | |
| | Example/ | Reaction | Reaction | | | | FW2/ |
| Sample | Comparative | temperature | time | Pressure | Main | D50 | FW1 |
| No. | Example | (° C.) | (h) | (MPa) | component | (nm) | (—) |
| A1 | Comparative | 57 | 3 | 0.000 | Co | 22 | 0.9 |
| | Example | | | | Co | | |
| A1a | Comparative | 57 | 3 | 0.000 | Co | 22 | 0.9 |
| | Example | | | | Co | | |
| A1b | Comparative | 57 | 3 | 0.000 | Co | 22 | 0.9 |
| | Example | | | | Co | | |
| A1c | Comparative | 57 | 3 | 0.000 | Co | 22 | 0.9 |
| | Example | | | | Co | | |
| A1d | Comparative | 57 | 3 | 0.000 | Co | 22 | 0.9 |
| | Example | | | | Co | | |
| A1e | Comparative | 57 | 3 | 0.000 | Co | 22 | 0.9 |
| | Example | | | | Co | | |
| A2 | Example | 57 | 3 | 0.010 | Co | 19 | 1.1 |
| A2a | Example | 57 | 3 | 0.010 | Co | 19 | 1.1 |
| A2b | Example | 57 | 3 | 0.010 | Co | 19 | 1.1 |
| A2c | Example | 57 | 3 | 0.010 | Co | 19 | 1.1 |
| A2d | Example | 57 | 3 | 0.010 | Co | 19 | 1.1 |
| A2e | Example | 57 | 3 | 0.010 | Co | 19 | 1.1 |
| B5a | Example | 57 | 1 | 0.010 | Co | 3 | 1.1 |
| B6a | Example | 57 | 12 | 0.010 | Co | 50 | 1.1 |
| B25a | Example | 57 | 1 | 0.200 | Co | 3 | 5.0 |
| A7a | Example | 57 | 3 | 0.200 | Co | 19 | 4.9 |
| B26a | Example | 57 | 12 | 0.200 | Co | 49 | 4.9 |
| G11 | Example | 170 | 5 | 0.200 | Co | 68 | 4.8 |
| G11a | Example | 170 | 5 | 0.200 | Co | 68 | 4.8 |
| G11b | Example | 170 | 5 | 0.200 | Co | 68 | 4.8 |
| G11c | Example | 170 | 5 | 0.200 | Co | 68 | 4.8 |
| G11d | Example | 170 | 5 | 0.200 | Co | 68 | 4.8 |
| G11e | Example | 170 | 5 | 0.200 | Co | 68 | 4.8 |

| | Composite | | | |
|---|---|---|---|---|
| | magnetic body | | | |
| | Content ratio of | Magnetic characteristics at 5 GHz | | |
| Sample | nanoparticles | Magnetic permeability | Magnetic loss | |
| No. | (vol %) | μ′ | tanδ | Performance index |
| A1 | 10 | 1.05 | 0.068 | 15.4 |
| A1a | 20 | 1.18 | 0.100 | 11.8 |
| A1b | 30 | 1.39 | 0.160 | 8.7 |
| A1c | 40 | 1.62 | 0.195 | 8.3 |
| A1d | 50 | 1.79 | 0.232 | 7.7 |
| A1e | 60 | 1.92 | 0.272 | 7.1 |
| A2 | 10 | 1.24 | 0.071 | 17.5 |
| A2a | 20 | 1.60 | 0.106 | 15.1 |
| A2b | 30 | 2.05 | 0.171 | 12.0 |
| A2c | 40 | 2.48 | 0.215 | 11.5 |
| A2d | 50 | 2.83 | 0.250 | 11.3 |
| A2e | 60 | 3.20 | 0.297 | 10.8 |
| B5a | 40 | 2.44 | 0.206 | 11.8 |
| B6a | 40 | 2.54 | 0.233 | 10.9 |
| B25a | 40 | 2.62 | 0.226 | 11.6 |
| A7a | 40 | 2.68 | 0.235 | 11.4 |
| B26a | 40 | 2.75 | 0.252 | 10.9 |
| G11 | 10 | 1.45 | 0.132 | 11.0 |
| G11a | 9 | 1.40 | 0.080 | 17.5 |
| G11b | 8 | 1.36 | 0.029 | 46.9 |
| G11c | 7 | 1.29 | 0.009 | 143.3 |
| G11d | 6 | 1.25 | 0.004 | 312.5 |
| G11e | 5 | 1.20 | 0.002 | 600.0 |

As shown in Table 13, even in examples (Sample A2a to Sample A2e) in which the content ratio of the nanoparticles was set to more than 10 vol %, the high magnetic permeability and the high performance index were compatible with each other at a high-frequency band as in the example (Sample A2) in Experiment 1. In addition, as shown in Table 13, even in examples (Sample G11a to Sample G11e) in which the content ratio of the nanoparticles was set to less than 10 vol %, the high magnetic permeability and the high performance index were compatible with each other at a high-frequency band as in the example (Sample G11) in Experiment 4. In addition, from the results in Experiment 7, it could be seen that the content ratio of the nanoparticles is preferably 5 vol % to 40 vol % from the viewpoint of further reducing the magnetic loss.

### EXPLANATIONS OF LETTERS OR NUMERALS

1 METAL MAGNETIC POWDER

2 NANOPARTICLE

10 COMPOSITE MAGNETIC BODY

6 RESIN

100 INDUCTOR

50 COIL PORTION

60, 80 EXTERNAL ELECTRODE

What is claimed is:

1. A metal magnetic powder comprising Co as a main component, and has an average particle size (D50) of 1 nm to 100 nm,
wherein an X-ray diffraction chart of the metal magnetic powder has a first peak that appears in a range of a diffraction angle 2θ of 41.6±0.3°, and a second peak that appears in a range of a diffraction angle 2θ of 47.4±0.3°, and
a ratio (FW2/FW1) of FW2 to FW1 is 1 to 5,
in which a full width at half maximum of the first peak is set as FW1, and a full width at half maximum of the second peak is set as FW2.

2. The metal magnetic powder according to claim 1, wherein
a ratio (I2/I1) of I2 to I1 is 1 to 10,
in which an integrated intensity of the first peak is set as I1, and an integrated intensity of the second peak is set as I2.

3. The metal magnetic powder according to claim 1, further comprising
an additive element including at least one of Fe, Mg, and Cu.

4. A metal magnetic powder comprising:
metal nanoparticles having an average particle size (D50) of 1 nm to 100 nm and having a crystal phase of hcp-Co,
a ratio (FW2/FW1) of FW2 to FW1 is 1 to 5,
in which a full width at half maximum of an X-ray diffraction peak related to a (100) plane of hcp-Co is set as FW1, and a full width at half maximum of an X-ray diffraction peak related to a (101) plane of hcp-Co is set as FW2.

5. A composite magnetic body comprising
the metal magnetic powder according to claim 1.

6. An electronic component comprising
the metal magnetic powder according to claim 1.

7. An electronic component comprising:
the composite magnetic body according to claim 5.

8. A composite magnetic body comprising
the metal magnetic powder according to claim 4.

9. An electronic component comprising
the metal magnetic powder according to claim 4.

10. An electronic component comprising:
the composite magnetic body according to claim 8.
